(19) United States
(12) Patent Application Publication
(10) Pub. No.: US 2013/0117148 A1
(43) Pub. Date: May 9, 2013

(54) SOCIAL BUSINESS TO BUSINESS MARKETPLACE SYSTEM AND METHOD

(71) Applicants: Peter Koch, San Mateo, CA (US); David Tso, Fremont, CA (US)

(72) Inventors: Peter Koch, San Mateo, CA (US); David Tso, Fremont, CA (US)

(73) Assignee: Balluun, Inc., San Mateo, CA (US)

(21) Appl. No.: 13/659,756

(22) Filed: Oct. 24, 2012

Related U.S. Application Data
(63) Continuation of application No. 13/197,669, filed on Aug. 3, 2011.
(60) Provisional application No. 61/370,395, filed on Aug. 3, 2010.

(51) Int. Cl. G06Q 50/00

(52) U.S. Cl. CPC G06Q 50/01; G06Q 30/0635
USPC 705/26.7; 705/26.81

(57) ABSTRACT

A social business to business (B2B) marketplace and method are provided that provides a business to business network marketplace and facilitates social interactions between the participants in the plurality of B2B marketplace. The social business to business (B2B) network marketplace and method provide both public and private marketplaces and social interactions and allows to conduct business by ordering from storefront.

### PRIORITY CLAIMS/RELATED APPLICATIONS

This application is a continuation of and claims priority under 35 USC 120 to U.S. patent application Ser. No. 13/197,669, filed Aug. 3, 2011 and entitled “Social Business to Business Marketplace System and Method” and further claims priority under 35 USC 119(e) to U.S. Provisional Patent Application Ser. No. 61/370,395 filed on Aug. 3, 2010 and entitled “Social Business to Business Marketplace System and Method,” both of which are incorporated herein by reference.

### FIELD

The disclosure relates generally to a system and method of a business to business (B2B) marketplace and social networking in the B2B marketplace.

### BACKGROUND

Business to business (B2B) marketplace systems and methods are well known. In addition, social networking systems, such as Facebook, LinkedIn and the like, are also well known. These social networking systems permit users connect and to share information with each other, communication with each other and more generally be social with each other. However, there is not any known system that combines a B2B marketplace with a social networking aspect, but it would be desirable to do so since the business to business relationships that exist in a B2B marketplace would benefit from having the social networking aspect. Furthermore, it would be desirable to provide a business with access to and provide a medium to connect to enable conversations with its customers, other businesses, etc. within the same B2B system. Thus, it is desirable to provide a social business to business network marketplace system and method and it is to this end that the disclosure is directed.

### BRIEF DESCRIPTION OF THE DRAWINGS

FIG. 1 illustrates a social business to business (B2B) network marketplace platform;

FIG. 2 is a more detailed view of the social business to business (B2B) network marketplace of one private b2b network;

FIG. 3 is a block diagram of a social marketplace unit that is used to manage the social business to business (B2B) marketplace;

FIG. 4 illustrates an example of a database schema that enables the messaging of the social business to business (B2B) marketplace;

FIG. 5 illustrates the multi-level feeding system of the social business to business (B2B) marketplace; (we merged home into Company Wall)

FIG. 6 illustrates an example of the news feed that is part of the social business to business (B2B) marketplace with privacy filter settings ‘Partners’ (B to many B sharing); (since this page merged with Company Wall)

FIG. 7 illustrates various social e-commerce aspects of the social business to business (B2B) marketplace; basically describes a social feed structure attached to a shopping cart which allows transaction related conversations between seller and buyer (seller is seeing the feed in an opportunity after shopping cart was saved)

FIG. 8 illustrates an example of the company wall portion of the social business to business (B2B) marketplace (example, a public B2B conversation)

FIG. 9 illustrates various social e-commerce aspects of the social business to business (B2B) marketplace that includes the social CRM portion;

FIG. 10 illustrates an example of a database schema the enables the e-commerce and CRM portions of the social business to business (B2B) marketplace;

FIGS. 11 and 12 are a consolidated list of different ways to read/post a message in the social business to business (B2B) marketplace;

FIG. 13 is a list of different activity streams in the social business to business (B2B) marketplace;

FIG. 14 is a list of different ways to read/post a message (including activity streams) in the social business to business (B2B) marketplace;

FIG. 15 illustrates an example of the filtering for the home and MyCompany portions of the social business to business (B2B) marketplace;

FIG. 16 illustrates an example of the filtering for the MyPartners portion of the social business to business (B2B) marketplace;

FIG. 17 illustrates an example of a Company Wall with a privacy filter setting of coworker of the social business to business (B2B) marketplace

FIG. 18 illustrates an example of a my coworker wall of the social business to business (B2B) marketplace;

FIGS. 19-20 illustrates examples of activity streams of the social business to business (B2B) marketplace;

FIG. 21 illustrates an example of the private messaging provided by the social business to business (B2B) marketplace;

FIG. 22 illustrates an example of a private one-to-one message conversation that is provided by the social business to business (B2B) marketplace;

FIGS. 23 and 24 illustrate examples of the user interface of a private messaging tool of the social business to business (B2B) marketplace for a particular user;

FIG. 25 illustrates a user interface of the private conversation between two people using the social business to business (B2B) marketplace;

FIG. 26 illustrates a user interface of the private group conversation using the social business to business (B2B) marketplace;

FIG. 27 illustrates a user interface of the private messages between business partners using the social business to business (B2B) marketplace;

FIG. 28 illustrates a user interface of a message received status for a private message using the social business to business (B2B) marketplace;

FIG. 29 illustrates a user interface of a comment to a private message using the social business to business (B2B) marketplace;

FIG. 30 illustrates a user interface of a message received status for a private message using the social business to business (B2B) marketplace;

FIG. 31 illustrates a user interface of another comment to a private message using the social business to business (B2B) marketplace;

FIG. 32 illustrates a user interface of a third person who received a private message of the social business to business (B2B) marketplace;

FIG. 33 illustrates a user interface of another comment to a private message using the social business to business (B2B) marketplace; and

FIGS. 34-44 illustrates examples of the user interface when companies connect with each other and un-connect with each other.

### DETAILED DESCRIPTION OF ONE OR MORE EMBODIMENTS

The disclosure is particularly applicable to a software as a service architecture social B2B network marketplace system and method and it is in this context that the disclosure will be described. It will be appreciated, however, that the social B2B network marketplace system and method in accordance with the disclosure has greater utility because the system can be implemented using other architectures and using other components/elements that those specifically shown and described below and the disclosure is not limited to the architecture and components/elements shown and described below.

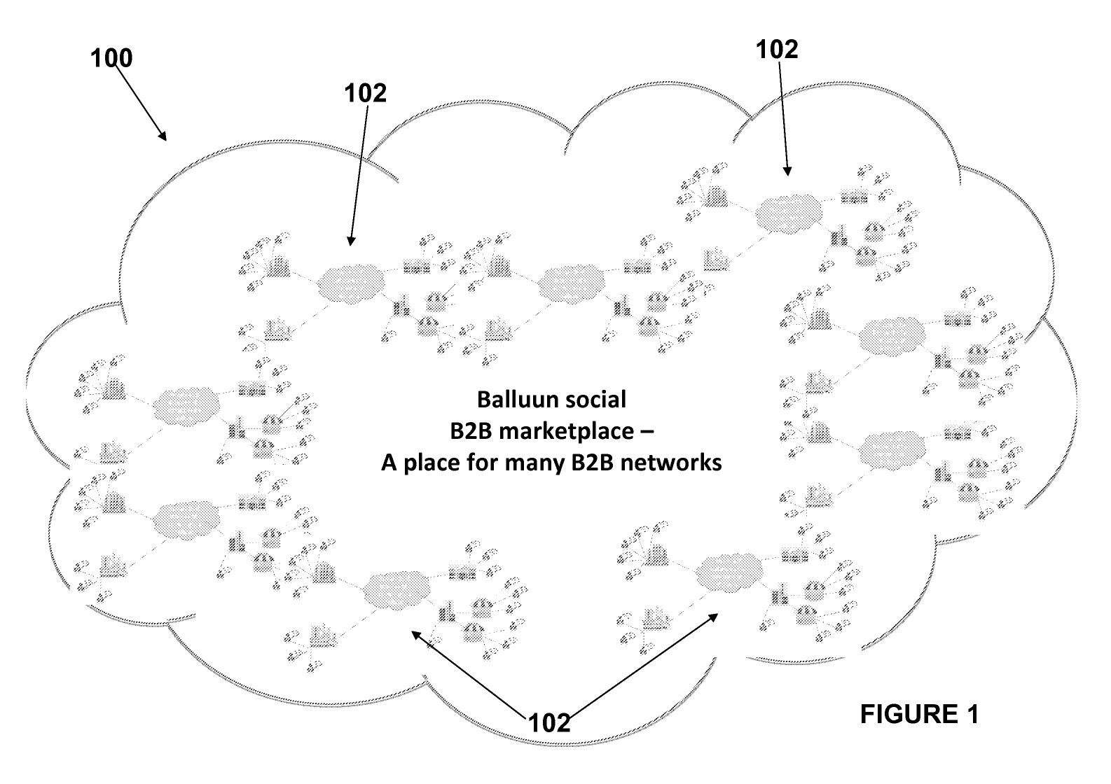

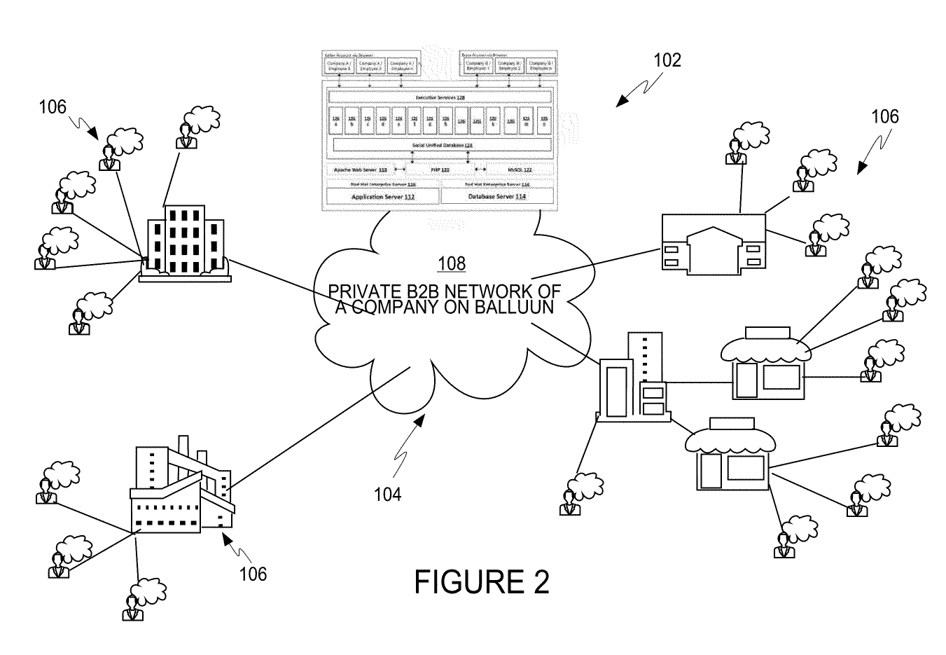

FIG. 1 illustrates a social business to business (B2B) network marketplace 100 in which a plurality of social B2B networks 102 (that may be typical B2B networks or other types of B2B market networks) are brought together with a social aspect (described below) to facilitate social interactions between the participants in each of the social B2B market networks 102 and between one participants and other participants. FIG. 2 is a more detailed view of a social business to business (B2B) network and in particular illustrates an example of one social B2B network 102 shown in FIG. 1. Each social B2B network 102 has a social network marketplace unit and connections/links 104 that interconnects one or more participants 106 in a private B2B network 108. When each social B2B market network 102 is connected to each other in the social business to business (B2B) marketplace 100, the dedicated private networks 102 are maintained, but a public forum (which each participant to opt to participate in at various levels) is also created that allows social interaction using the social network marketplace unit and connections/links 104 while maintaining the private B2B networks 102 as described below in more detail.

The resulting system 100 provides multilevel feeding of social interaction and conversations including: a business to many other business conversation/activity (public and private), a intra company conversation/activity using the private B2B network, a person to person or person to many person conversion/activity within a private network, a private business to business conversion/activity over a private network, a private business to business personal conversion/activity over a private network, a private business to business object related conversation/activity using a private B2B network about goods/services being negotiated, bought or sold, a private business to business object related conversation using a private B2B network about business opportunities, a private business to business object related conversation using a private B2B network about a service/good order, a private business to business object related conversation using a private B2B network about managing a goods/services order and/or a private business to business object related conversation using a private B2B network about customer service. Each of these different types of conversions/interactions are facilitated by the system and method that are now described in more detail. Also a private message system spanning across the connected companies to communicate in a private messaging style (similar to Facebook or linkedin's messaging service) is also enabled allowing participants to write private messages beside the social feed by utilizing the social b2b relationship.

The social B2B network marketplace system provides beside a storefront concept for seller companies to sell and buyer companies to buy a microblogging capability to all participants of the social marketplace B2B system. The microblogging capability allows the participants to have the communications, engagement, collaboration, activity and conversations above with each other. The systems and units that enable the microblogging are now described in more detail.

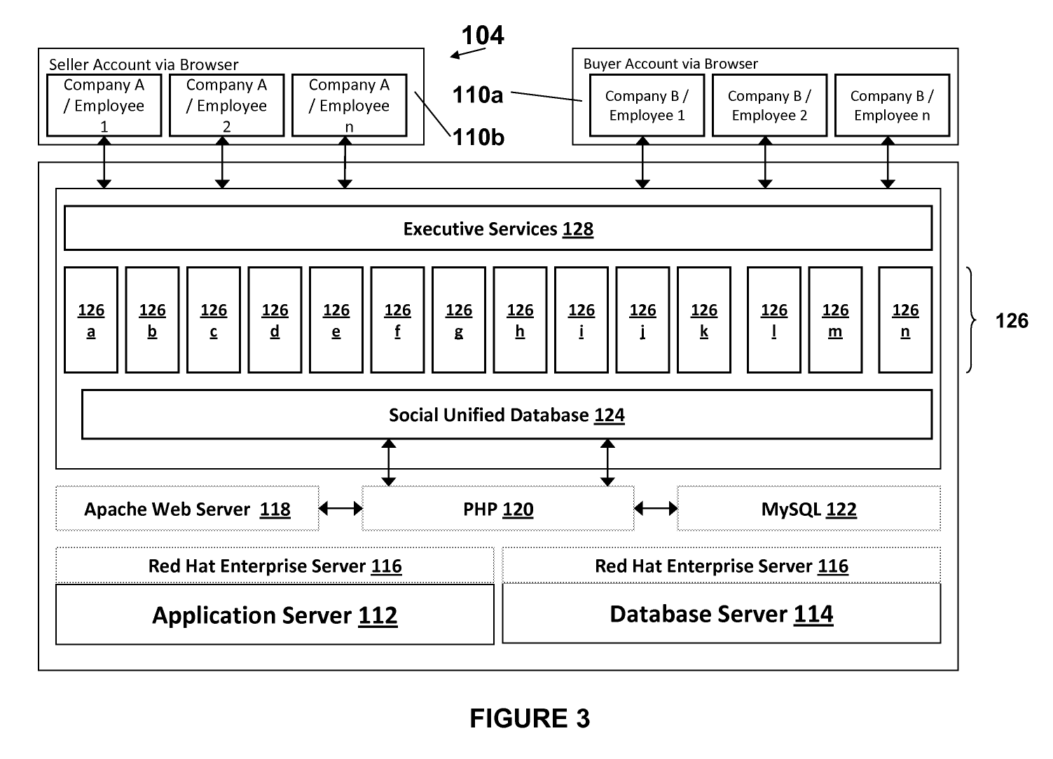

FIG. 3 is a block diagram of a social marketplace unit 104 that is used to manage the social business to business (B2B) network marketplace. One or more computing devices 110 (such as a seller account computing device 110b and a buyer account computing device 110a) can connect to the social marketplace unit 104 using well known protocols (whether secure or not) over a link that may be wired or wireless. In some embodiment, each seller account may be accessed by one or more employees of the seller (employee1, employee2, . . . , employee n) and each employee may have their own computing device 110. Similarly, each buyer account may be accessed by one or more employees (employee1, employee2, . . . , employee n) of the buyer and each employee may have their own computing device 110. Thus, the social marketplace unit 104 can be connected to by a plurality of sellers and buyers and a plurality of computing devices 110. Each computing device 110 may be a processing unit based device with a display, processing power and memory to be able to interact with the social marketplace unit 104. For example, each computing device may be a personal computer, a terminal, a laptop computer, a smartphone (Apple iPhone, RIM Blackberry device, HTC device or Palm device), a mobile phone with a digital data capability, a tablet computer and the like. In one embodiment, the computing device has an operating system and manages the functioning of the computing device and the computing device may also have a well known browser application (Mozilla, Safari, etc.) that is stored in the memory of the computing device and executed by a processor of the computing device to establish a connection with the social marketplace unit 104 and interact with the social marketplace unit 104 by exchanging data, images, video, web pages and the like.

The social marketplace unit 104 may further comprise one or more well known application servers 112 with one or more well known database servers 114 for scalability, troubleshooting and security reasons. The above components also provide load balancing as is known. In one embodiment, both the database and application servers 112, 114 may be running Linux—Red Hat Enterprise operating system software 116 as shown. The social b2b network marketplace unit 104 may further comprise a well known Apache Web Server 118, a known PHP 5.2.13 120 installed as well as a well known MySQL 5.0.77 122 and these provide the operating environment for the social B2B network marketplace that is running a social unified database 124 which allows the system to provide an integrated combination of a transaction enabled storefront and marketplace combined with the social connectivity and communication structure to provide an integrated connectivity service between companies and a communication service within a company account on the system but also between companies and filtered depending on the demand of level of privacy and integrity.

The system, in one embodiment, may be a software-as-a-service (SaaS) in the cloud and is protected by Firewall(s) and SSL encryption. The Firewall(s) may be a Cisco ASA5500 series firewall and the SSL Service is a Versign SSL encryption license and may encrypt every single page of the social B2B marketplace for security reasons. The system may also be implemented using other architectures such as a client server model, a hosted model, a cloud server model, a mainframe/terminal model and the like and is not limited to any particular architecture.

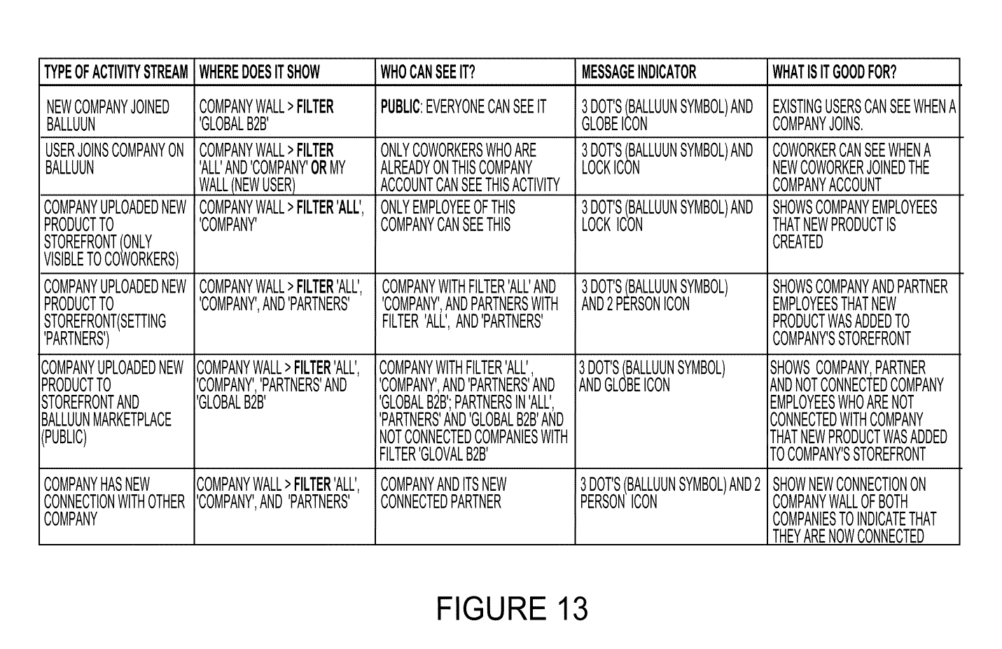

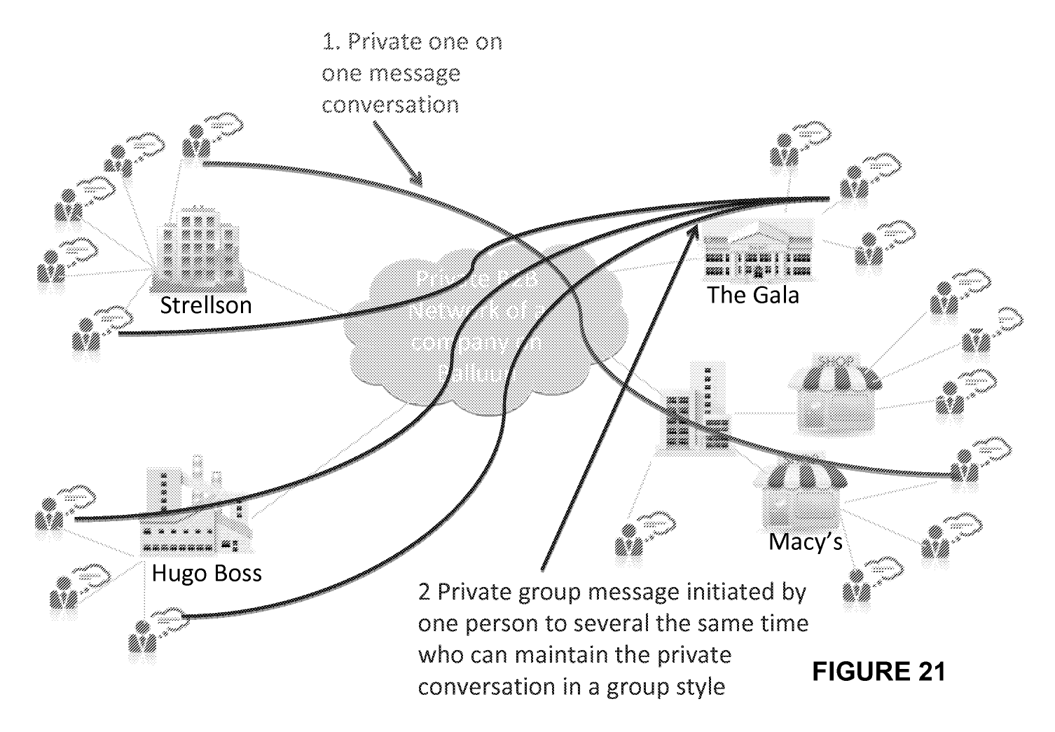

To provide the transaction-enabled storefront and marketplace combined with the social communication structure, the social network and marketplace unit 104 may further comprise one or more units 126 and an executive services unit 128 that provide the services and features. In one embodiment, each of the units 126 and the executive services unit 128 may be implemented as a plurality of lines of computer code that are executed by the one or more applications servers and database servers of the system. The units 126 may include a registration unit 126a that handles the registration of one to many users per company accounts and accounts of the system, a connectivity unit 126b that handles the connections between 2 or more companies on Balluun to create a private b2b network 102, a profile pages unit 126c that handles the company profiles pages as described below, a multilevel feeds unit 126d that handles the multilevel feeds as described below in more detail, a storefront unit 126e that generates and manages the storefront of each company on the social b2b marketplace, an inventory management unit 126f that manages products of a companies storefront and it's inventory, a shopping cart unit 126g that generates and manages the shopping cart between a buyer account and a seller account to allow the buyer to buy from a dedicated seller company storefront on balluun, a checkout unit 126h that generates and manages the checkout process of a shopping cart of a buyer from dedicated seller storefront, a CRM unit 126i that provides CRM services and features to the seller account based on his storefront as described below, a manage order unit 126j that manages orders for services and goods of the transactions (seller and buyer view) and provides a dynamic order template for ordering, a payment unit 126k that manages the payment process between seller and buyer on the social b2b marketplace with the API's into 3^{rd} party payment solutions (PayPal and other comparable third party payment solutions), a business intelligence unit 126l that provides typical business intelligence features to the marketplace, a recommendation engine that matches companies based on database records together. For example, the recommendation engine provides company matching based on a recommendation algorithm (for instance: build a recommendation service—seller>clothing>street wear to buyer>clothing>street wear for instance)+social relationship (social graph) of 1st, 2nd and 3rd degree of relationships.) The units 126 further may include an activity streams unit 126m that generates and manages the activity streams (described below in more detail with reference to FIGS. 13 and 19-20) and a private messaging unit 126n that generates and manages the private messaging that is described below in more detail with reference to FIGS. 21-33. The units 126 and executive unit 128 combine a mix of features and functionality to provide the service. Each of the features and functionality takes advantage of the unified social database of social, company, product and transaction related data and delivers the required feature output as a user interface to the user. The structure filters the service and provides the required subset of the features as a buyer account, a seller account and a master/admin account (balluun master account) or just based on the features subscribed which are described below in more detail.

Using the social B2B network marketplace, a company or company division can create a company account with one to MANY employees under this company account. In other words, each company account on the system consists of a Company Profile and a sub Profile structure for every single employee as well. The relationship between employees within one company are therefore all related with each other and represent one company on the system. Employees can be added to a company account at any time. Furthermore, a company can invite and connect with any company which has an account on the social B2B system. The system, for example, can connect a manufacturer-manufacturer relationship, a manufacturer-wholesaler relationship, a wholesaler-wholesaler relationship, a wholesaler-retailer relationship, a wholesaler-reseller relationship, a retailer retailer relationship, a reseller-reseller relationship and/or a wholesaler-retailer/reseller relationship.

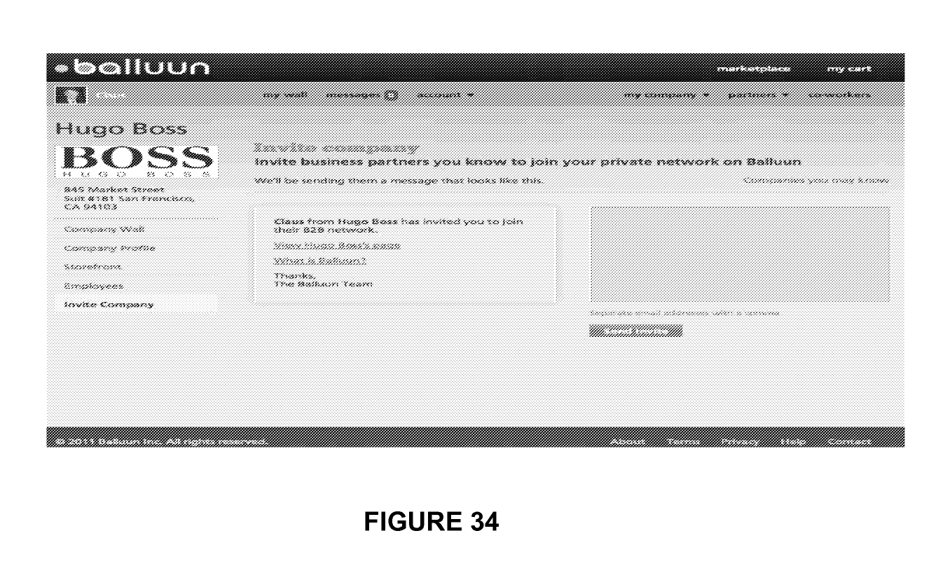

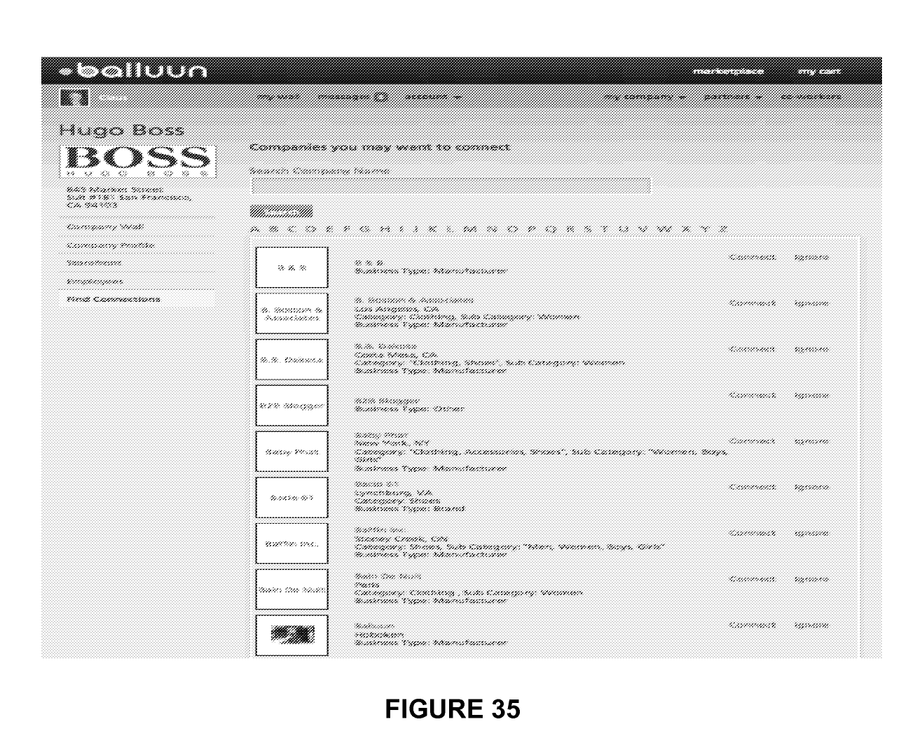

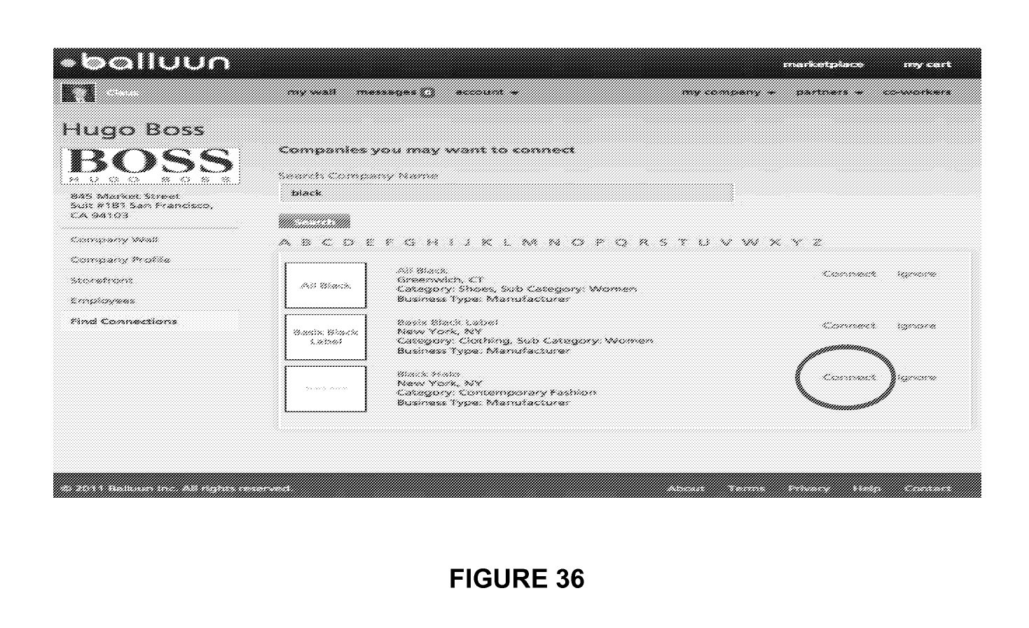

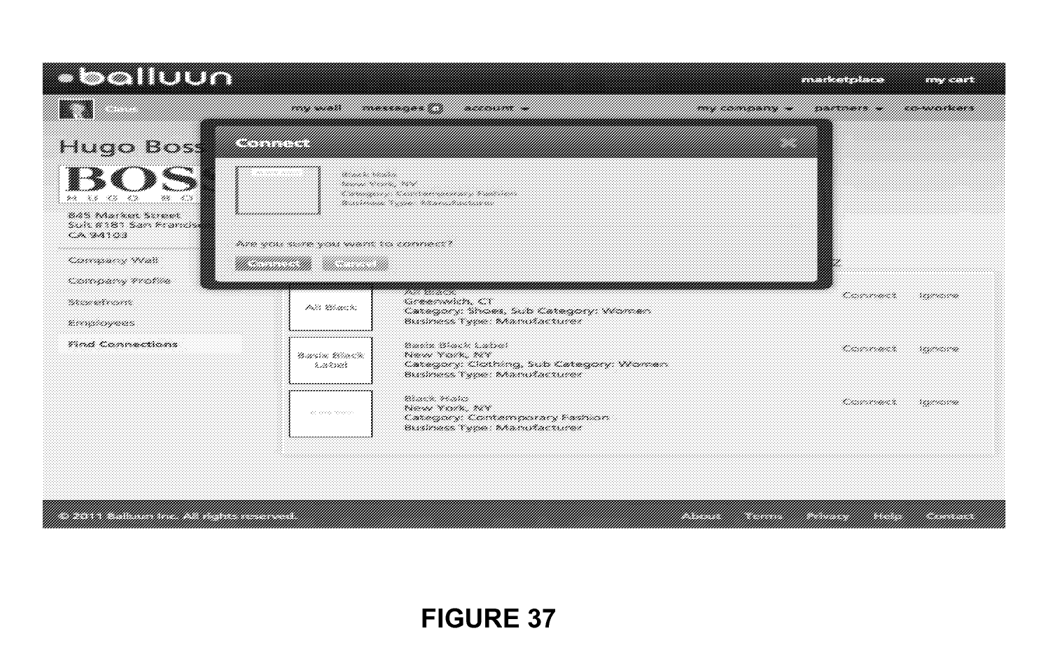

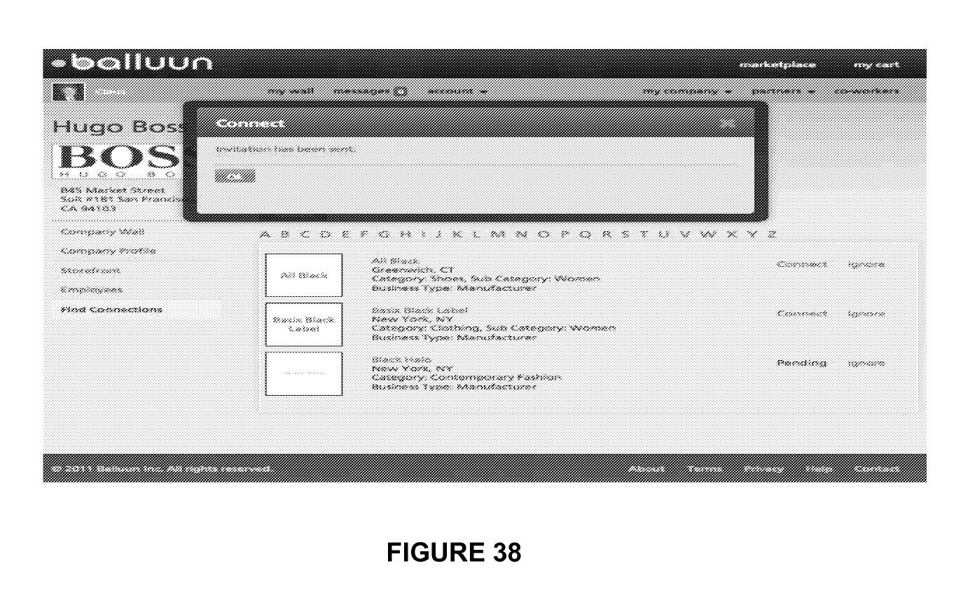

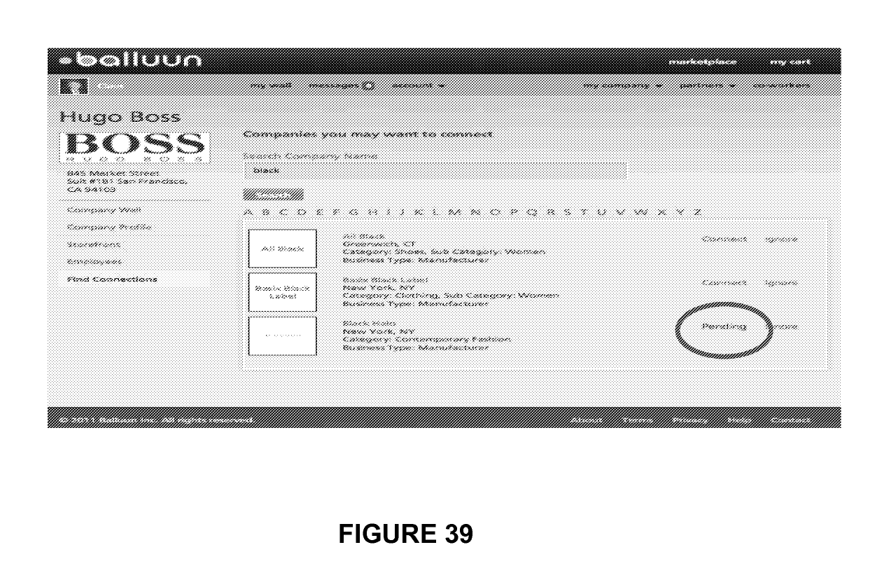

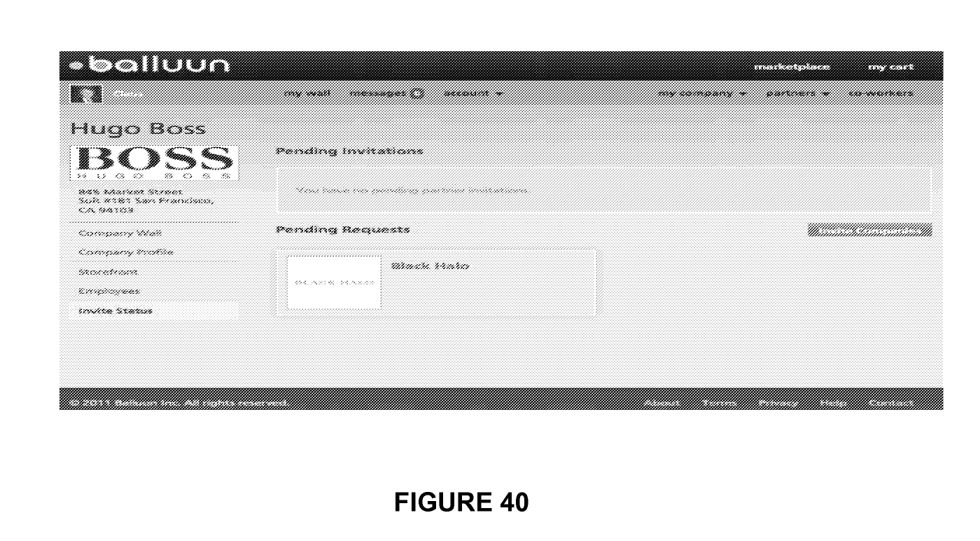

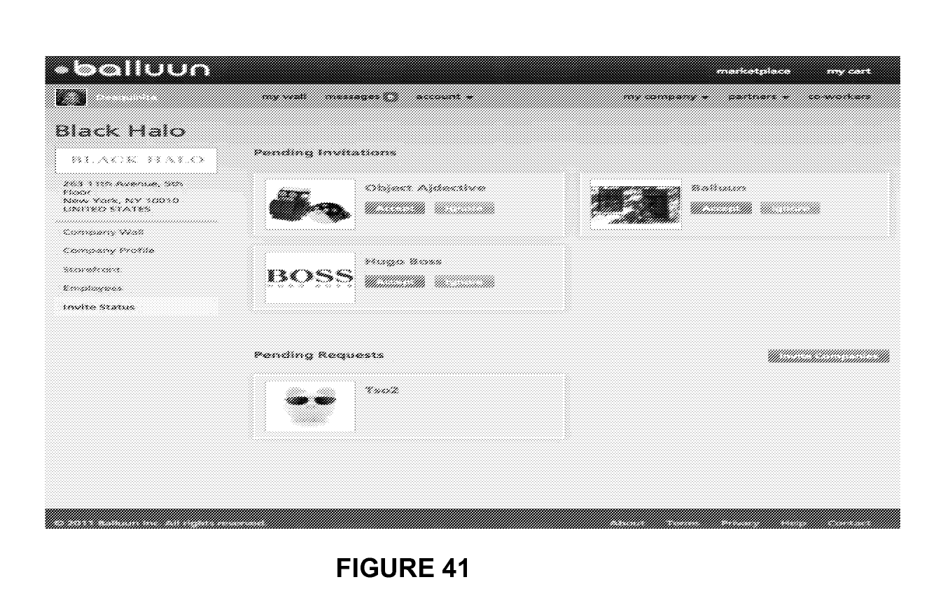

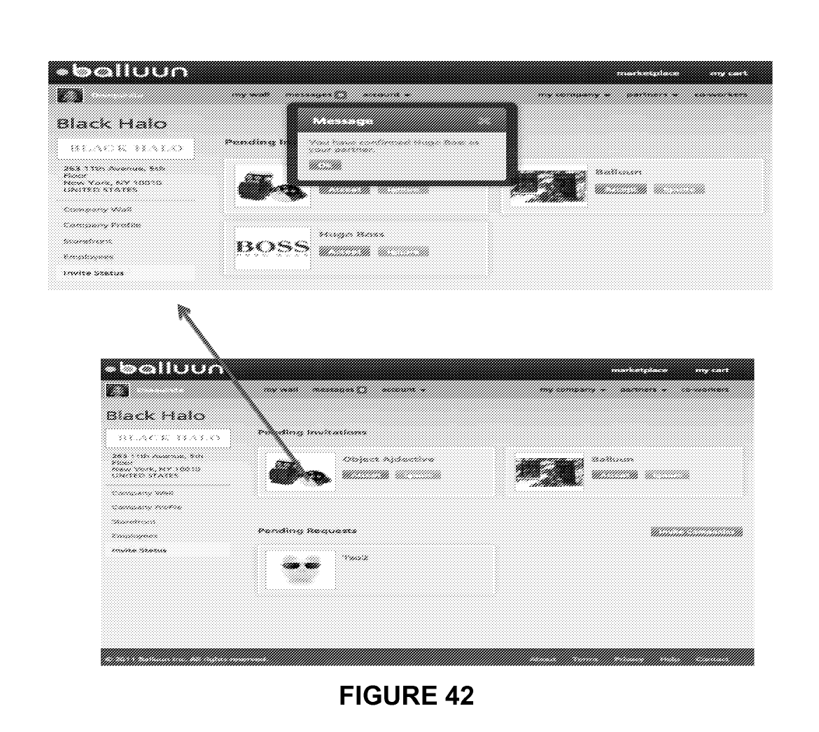

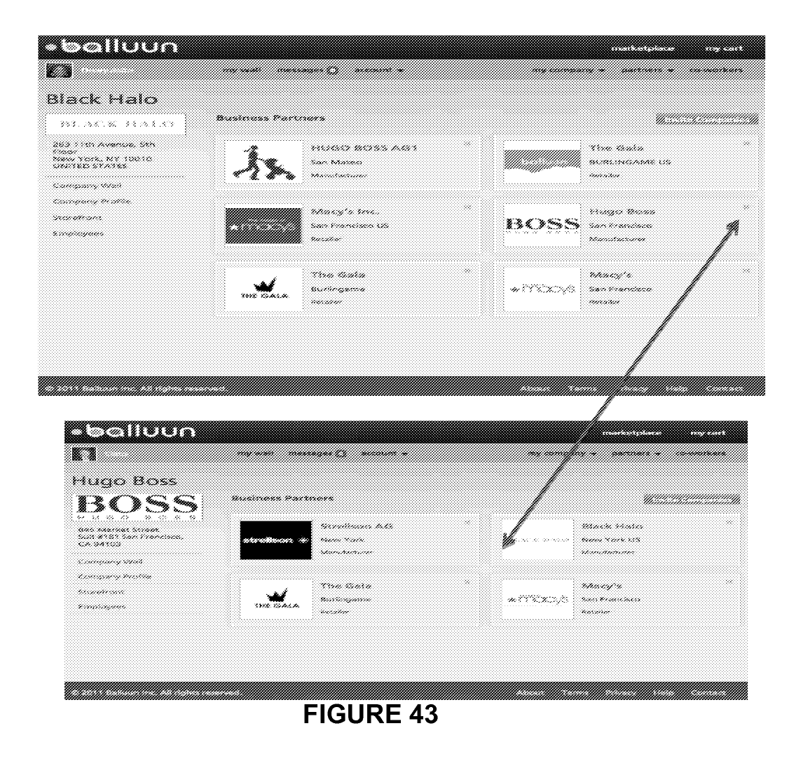

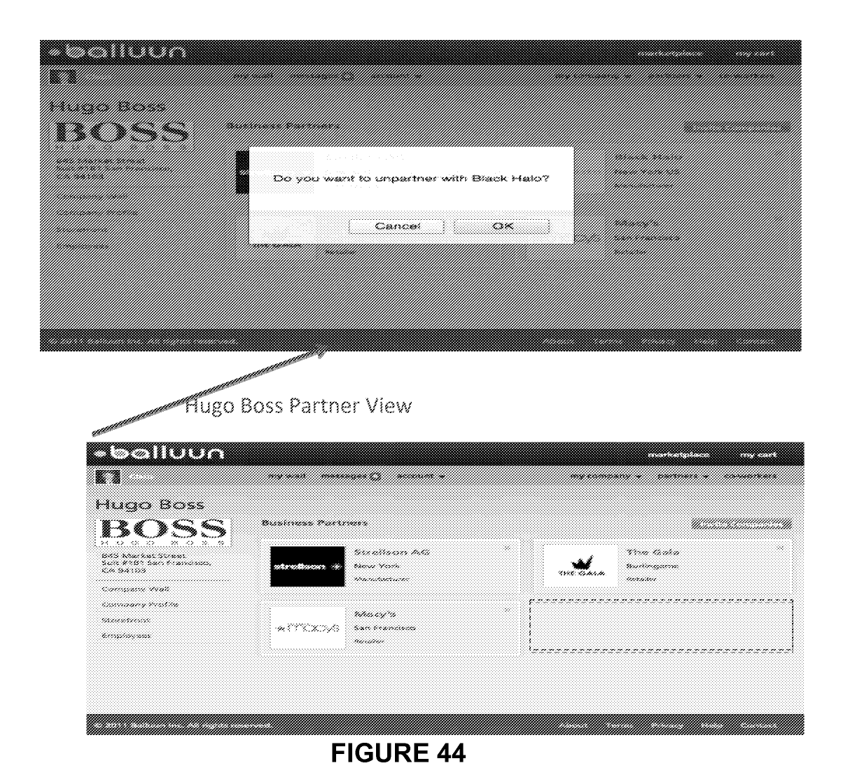

The connect works by one company inviting one company inviting another company (see FIGS. 34-39 for examples of the process for inviting a new company) and the invited company confirms the invitation request (see FIGS. 40-42 for examples of this process). FIG. 43 shows an example of the user interface of each company after the invitation has been accepted. FIG. 44 shows an example of the user interface when a company un-partners with a company. With the system, as soon as two companies are connected, they can communicate with each other using the multi-level feeding structure and/or private messaging or conduct business with each other (ecommerce transactions). In addition, a company which invited multiple companies to join it's network is maintaining it's own B2B community on the system as well. Furthermore, there can be many independent B2B communities relative to a given company. The community can be all connected businesses or a sub-group of coworkers and/or it's employees grouped into a dedicated group.

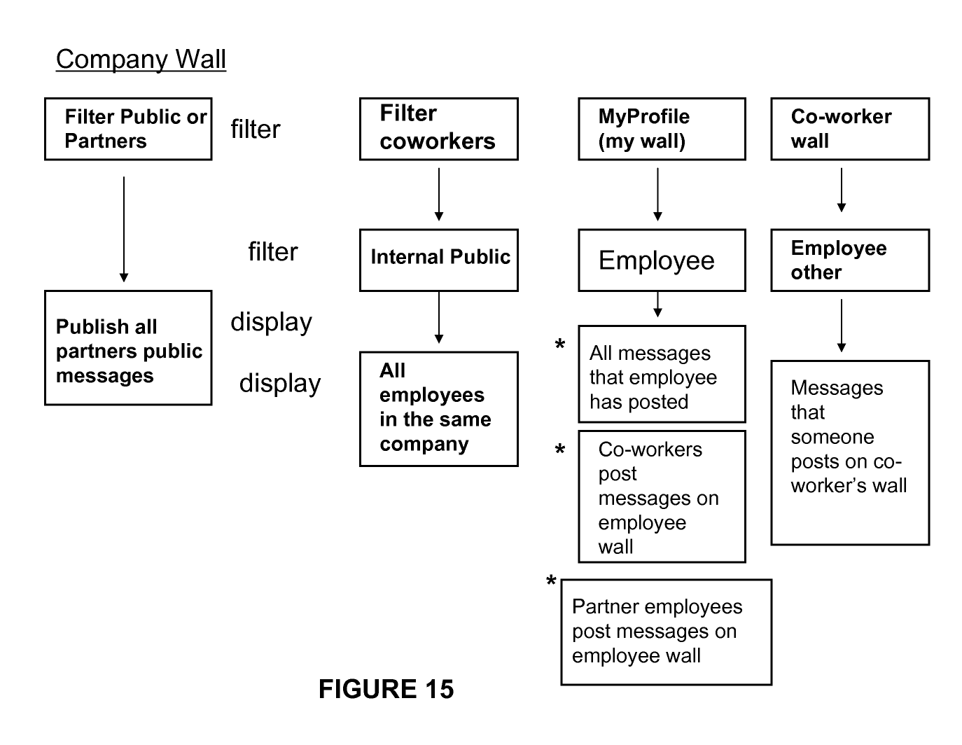

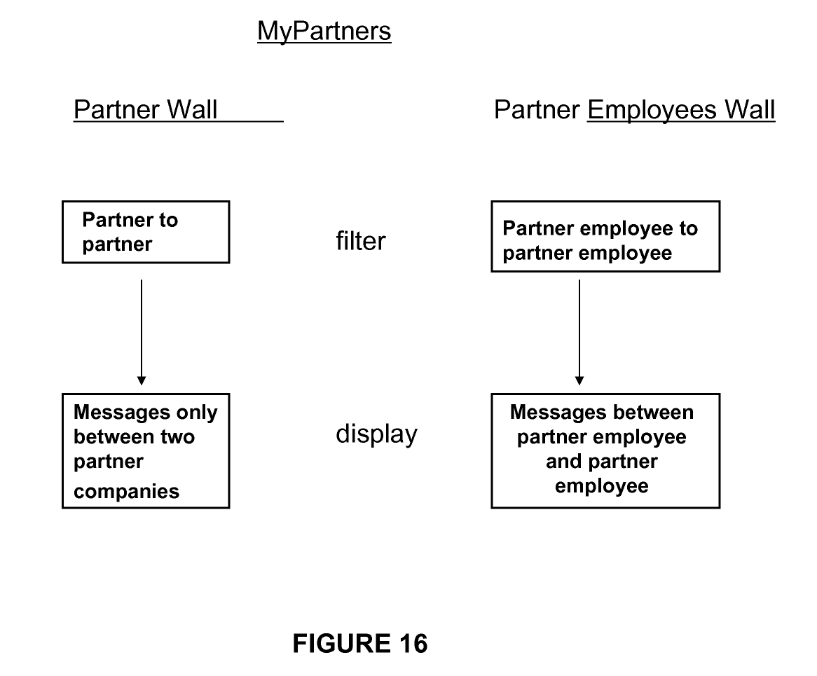

The B2B network marketplace has the multi-level feeding structure. In the Company Wall of the B2B network marketplace (for inter and intra company conversations), the system may provide to post: a public filter that filters for everyone on Balluun (twitter like advertising/blogging); a partner filter for Business 2 many Businesses (all my business connections); and a coworker filter for intra company conversation (all my coworkers). In the My Wall portion of the B2B network marketplace (for inter & intra conversation (P2P, P2manyP) for post's, the system may provide: a public filter that filters for everyone on Balluun (twitter like advertising/blogging); a partner filter that filters for business 2 many Businesses (all my business connections); and a coworkers filter that filters for intra company conversations (all my coworkers). The My CoWorker Wall portion of the B2B network marketplace is for inter & intra conversation (P2P, P2manyP) with only threads towards or with that particular coworker involved). The system also provides a Partner Wall in a My Partner portion that is for inter conversation (private B2B) for only threats between me or my company with that particular partner. The system also has an Employee Wall that is part of the My Partner portion of the system that contains messages about inter conversation (private B2B personal) with only threads between me or my coworker with that particular partner employee. The system also has an ecommerce shopping cart check out process that provides inter conversation (private B2B object-related) which are conversations between seller and buyer related to this transaction. The system also provides My Company Opportunity that provides inter conversation (private B2B object-related) which are conversations between seller and buyer related to this opportunity. The system also have ecommerce myorders feeds that are inter conversation (private B2B object-related) between seller and buyer related to this order and orders/manage orders feeds that are inter conversation (private B2B object-related) between seller and buyer related to this order. The system may also have a customer Service feed that is an inter conversation (private B2B object-related) between seller and buyer related to this transaction. The system may also provide filtering of the messages that is described below with reference to FIGS. 15-16.

The B2B network marketplace also has the multi-level activity streams. Activity streams are user generated activities which are mixed into the social feed. Users can respond to activity streams as they can to postings, which makes activity stream an integrated part of social feeds and allows engagement. In more detail, when a user is doing something or 2 companies are connecting or transacting, the system creates activity streams which flow into the social feed structure indicating what is happening on the system based on activity. The activity stream is part of the social feed structure allowing users to even respond back with a response feed to an activity stream and cause interaction with other users. Examples of the multi-level activity streams are:
Company Wall
   Global B2B—“Company X’ just joined Balluun’,—‘Company X just added a product to it's storefront’ (privacy setting of Product is ‘Public’, ‘Company Y just activated it's storefront’
   Partner—‘Company X just added a product to it's storefront’ (privacy setting of Product is ‘Partners’)
   Transaction—‘Company’ A just created a shopping cart with you’, ‘Company A just submitted order to you’, etc.
   Company—‘Coworker B just joined your team on Balluun,—‘Company X just added a product to it's storefront’ (privacy setting of Product is ‘Coworker’, ‘Coworker B just uploaded a new logo for your company’
My Wall
   ‘You just joined Company Z on Balluun’
Co Worker Wall
   ‘Coworker B joined your team on Balluun’, ‘Coworker B uploaded a new logo for your company’
My Partner>Partner Wall
   ‘Company X added a product to it's storefront’ (privacy setting of Product is ‘Partners’)
My Partner>Employee Wall only threats
   “Partner Employee Name’ uploaded a new image to his wall’
E-Commerce>shopping cart/checkout process
   ‘You added product xyz to your cart at Company A’
My Company>Opportunity
   ‘Company X just created a shopping cart on your storefront’
E-Commerce>My Orders
   ‘Company X just submitted purchase order to you’
Orders>Manage Order
   ‘Company X just made payment to purchase order xyz’
Customer Service (future)
   ‘Company X just flagged transaction for customer service review’

The social network marketplace unit provides social networking in and among the users/partners/buyer/sellers of the social marketplace unit and all of the other users/partners/buyer/sellers of the social marketplace unit. The social marketplace unit enables private messages between one or more of the parties. The social marketplace unit ‘also’ enables a message broadcast to all partners of a user so that, for example, Company A can broadcast messages to Company B, Company C and Company D and these also permit all of the parties involved in the broadcast message to respond to all of the other parties.

The social network marketplace unit also enables communications between a partner and another partner. For example, Company A can communicate with Company B, but Company C cannot gain access to the messages between Company A and Company B. Thus, the social marketplace unit enables private conversations between users of the social marketplace unit (private B to B).

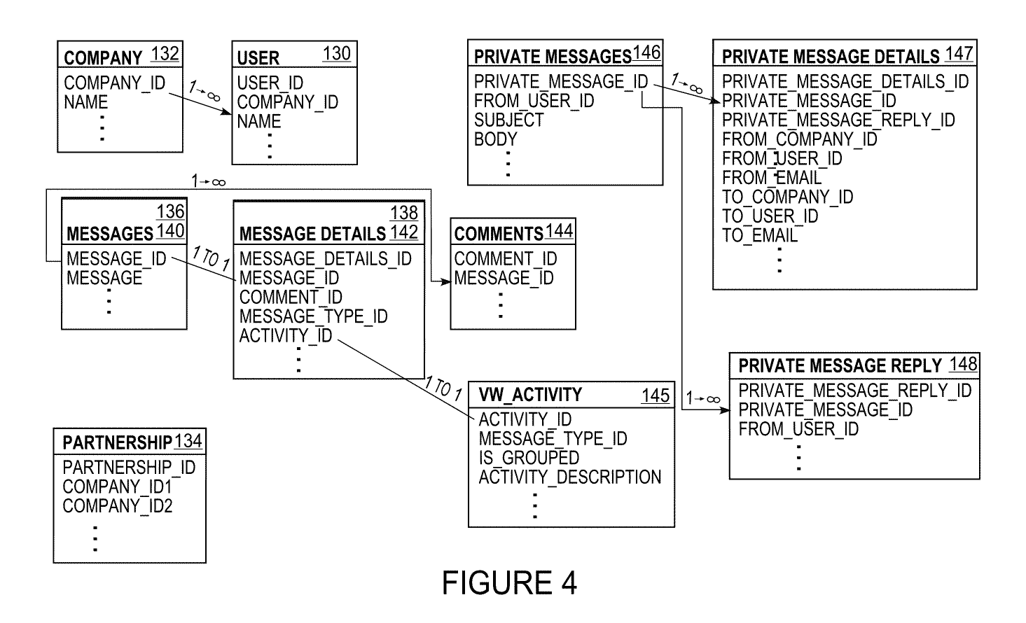

FIG. 4 illustrates an example of a database schema that enables the messaging of the social business to business (B2B) network marketplace. It should be understood that the marketplace system may use other database schemas that are within the scope of the disclosure and the example in FIG. 4 is for illustration purposes only. In the example shown in FIG. 4, a relational database is used with a plurality of database records that have relationships with each other. For example, the database schema may include a user database record 130, a company database record 132, a partnership database record 134, a user message database record 136, a user message details database record 138, a messages database record 140, a message details database record 142 and a comment database record 144. As shown in FIG. 4, the user and company database records may have a 1 to many relationship and the user message and user message details database records are also related. As also shown, the messages and message details database records have a 1-to-1 relationship and the comment database record has a relationship to the message details database record. Using the above database schema, the marketplace system stores the data to be able to enable the various messaging of the system. For example, the partnership messaging is enabled by the partnerships database record that stores the data about each partnership and the each company that is part of each partnership. The messaging schema may also include a private message record 146, a private messages detail record 147 and a private message reply record 148. These have the same relationship and similar fields as the message and message details records above.

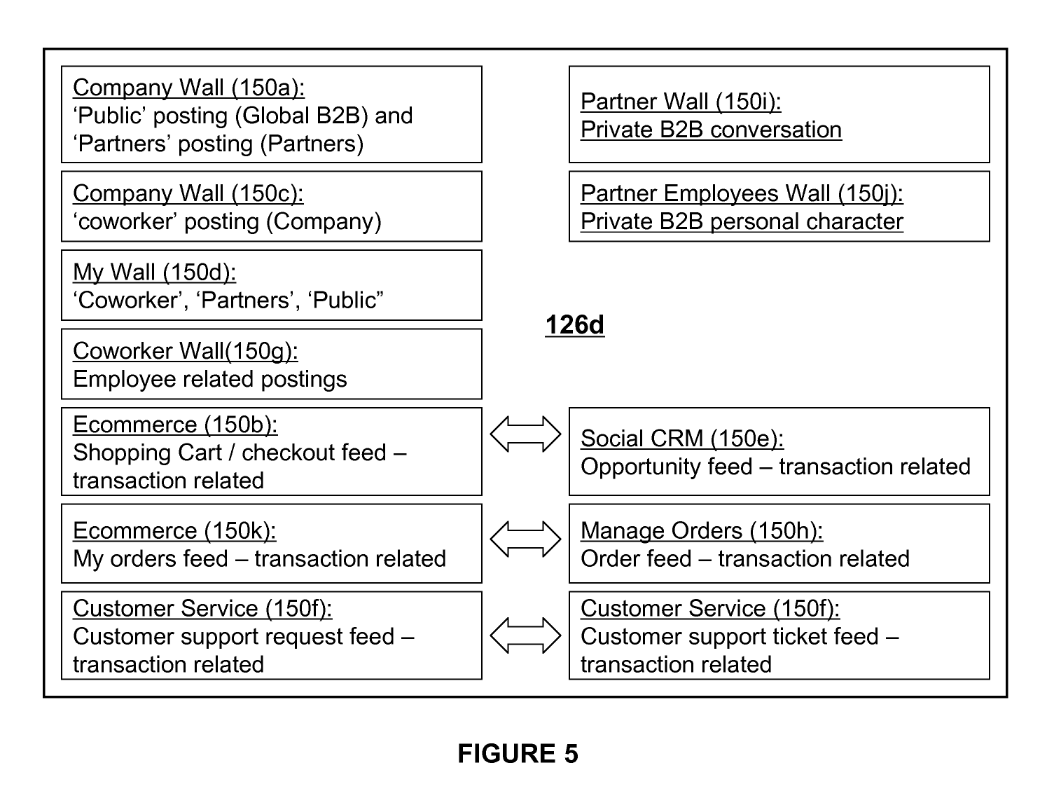

FIG. 5 illustrates the multi-level feeding system 126d of the social business to business (B2B) marketplace. The system/unit may include a B2B news feed (privacy filter ‘public’ and ‘partners’ —for a b2-manyPartner conversation) portion 150a that enables business to many business conversations/communications and an ecommerce>shopping cart portion 150b that enables a checkout process and inter company conversations/communications that are private between the two companies that relate to an object/service being purchased using the marketplace. The system/unit also may include an ecommerce>My orders portion 150k that enables inter-company/participant conversations/communications that may be private business to business object related conversations/communications about the orders that are part of the ecommerce system of the marketplace. The system/unit also may include an customer service portion 150f that enables inter-company/participant conversations/communications that may be private business to business object related conversations/communications about customer service issues. The system also may include an intra-company portion that enables intra-company conversations. The system also may include an coworker-to-coworker portion that enables co-worker to coworker conversations.

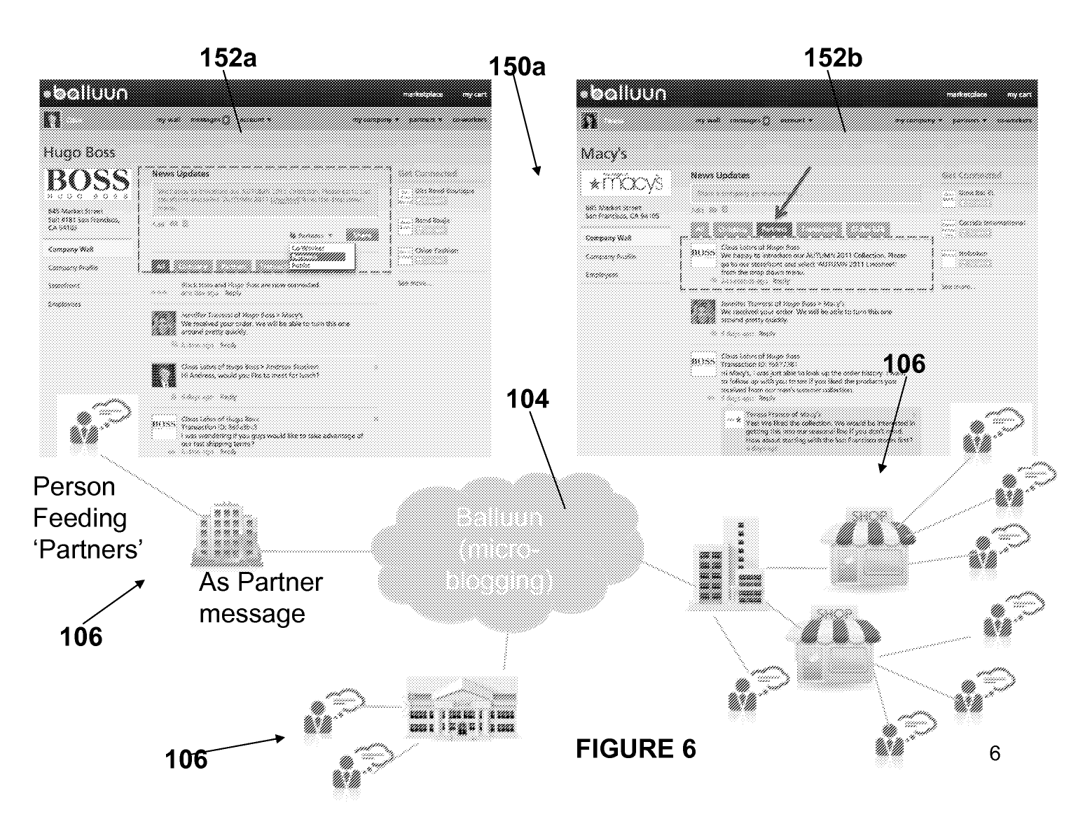

FIG. 6 illustrates an example of the news feed portion 150a that is part of the social business to business (B2B) network marketplace. A page 152 for each company 106, such as a web page in one embodiment, facilitates business to many other business communications (public and privateB2manyB) although only three companies are shown in FIG. 6. The place is on company wall with privacy filter ‘public’ or ‘partners’ filter at which a company can post outside facing content to it's business partners or any company following the feed, so that a company in or outside of a business network on the company wall will see a posting as a company announcement/posting (under Global B2B/public filter or Partners filter.) The news feed also may be used, for example, to post company news, product news and event news to the company's business partners. Since adding an image or a file to the feed also is possible, the news feed allows the company to send collateral to business partners in a mass marketing/posting initiative.

The social network marketplace system may also have a super user news feed for the system owner and administrator. The super user may be either always connected to every customer and/or the super user news wall is used to communicate announcements out to the user of the system clients about: events of the marketplace system, feature announcements, product lessons and value propositions, for example, etc.

Postings on news feeds will also display the same feed into the company wall and your profile page (if you are the person who has sent the message) or your co worker (person) who has posted the message. This gives the company the information what each person has feeded but also gives a person, as the co-worker, the information who has feeded on B2B News feed from your team. The feeds posted are public to everyone following this service or to all connected business partners. Now, the social e-commerce aspect of the system is described in more detail.

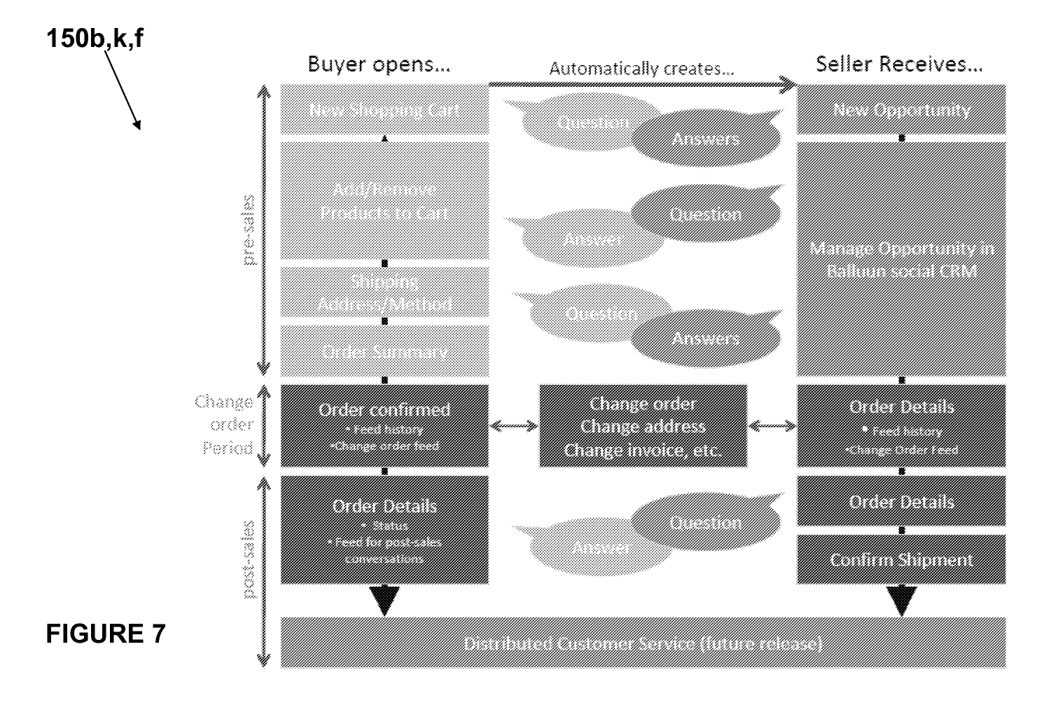

FIG. 7 illustrates various social e-commerce aspects 150 b, f, k of a dedicated storefront of the social business to business (B2B) network marketplace. FIG. 7 illustrates an example of the e commerce processes of the social business to business (B2B) network marketplace.

In the shopping cart portion 150b, as soon as a buyer is adding products of a seller's storefront to a cart, the system creates a shopping cart for that buyer for the particular seller and the system creates a social feed to the shopping cart ID. In the system, a buyer is provided with a separate shopping cart for each sellers’ storefront. Throughout the shopping tour on seller's storefront, the buyer can add, remove, change products to the cart and the buyer is able to communicate with seller. For example, the buyer can ask or answer questions, and discuss terms with the seller. The buyer is able to stay engaged in discussions and/or negotiations with this seller during the shopping process. Even when buyer is taking shopping cart through the check-out, buyer and his co-workers are able to communicate with the seller to discuss address information, shipping terms, payment terms, etc. After the Order is submitted, the cart for the particular seller is closed and Order Details becomes available under Orders Tool. From there the buyer is able to see order details, look into the conversation trail related to this purchase as well as can have new conversations with seller about post-sales activities (shipping, etc.)

In the myorders portion 150k, a buyer (under the My Orders tab) can review his/her latest or previous orders and from that user interface, can review the whole conversation trail within a transaction. From this user interface, the user can start new conversations related to the order/transaction.

The orders portion of the system may provide a dynamic order template that is generated based on the per product set up of attributes. For example, in clothing, it would be size and color and then displayed in a 2 dimensional order template form for a professional buyer to buy the quantities per size and color combination needed. The template can be only one quantity box, it can be one dimensional to show multiple sizes someone can order per product or a 2 dimensional order template where based on the attributes selected per product dynamically the order template is being generated

In the customer service portion 150f, the system is able to provide unique customer service. In particular, having the relation of the shopping cart/Opportunity (pre-sales) all the way to the post-sales process of Manage Order/My Orders with the related conversation trail based on the system's social feed structure allows the system to create a unique distributed customer service function taking the conversation even deeper into the seller and buyer relationship. Using the system, the system will be able to offer customer service tools to seller from repair, returns all the way to provide the BEST Customer Service for even tighter business relationship for un-reached customer satisfaction!

In the system, each company that is a user of the social b2b network marketplace may have their own areas of the marketplace (application) that may be known as MyCompany. In the MyCompany portion of the marketplace, each company may further have a company wall portion 150c that enables intracompany conversations/communications that are private, a myprofile (mywall) portion 150d that enables intra-company conversations/communications that may be employee to employee in the company and/or employee to many employees within the company and a coworker profile portion 150g that enables intra-company conversations/communications that may be employee to employee in the company and/or employee to many employees within the company. To post a company internal announcement user can use the mywall view or company wall view (select privacy filter ‘coworkers’) and can post to all his coworkers who have an account under this company account. If he wants to write onto another coworkers wall, user can go to coworkers overview page, select the coworker he wants to write and clicks to that coworkers wall. This is considered a coworker to coworker posting from wall to wall.

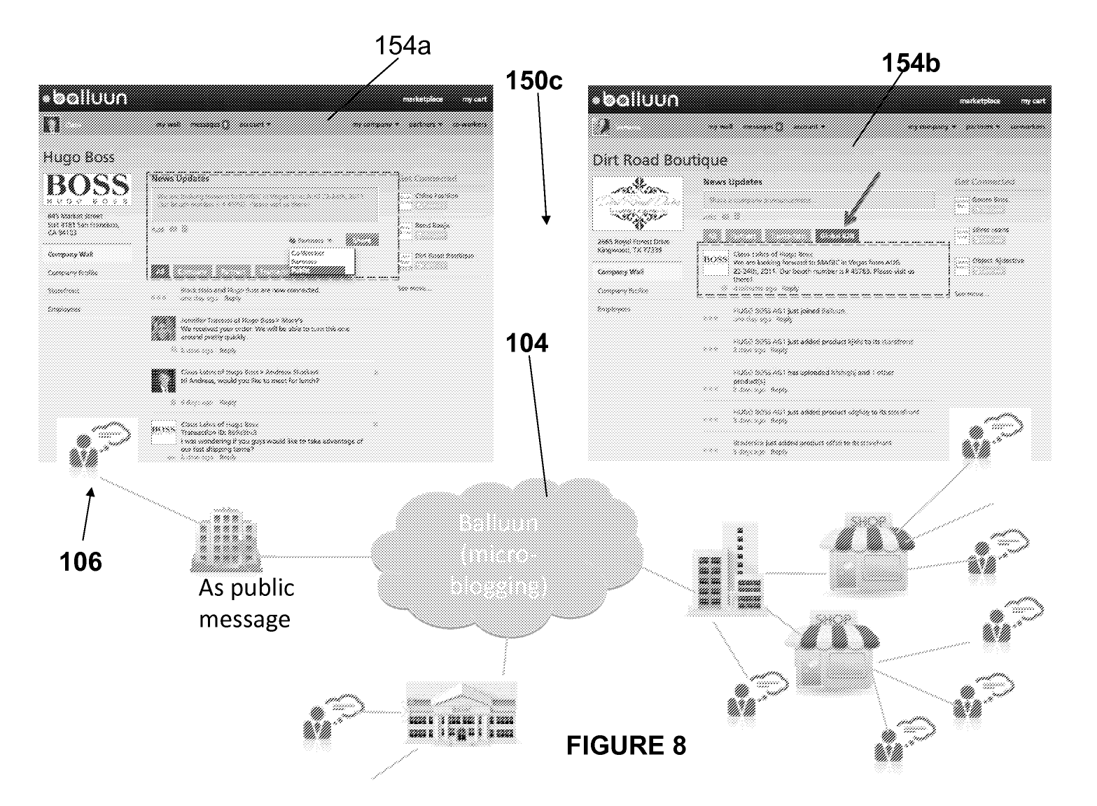

FIG. 8 illustrates an example of the company wall portion 150c of the social business to business (B2B) network marketplace. A page 154 for each company/participant 106, such as a web page in one embodiment, facilitates internal and external conversations. The page is a location that is meant for company internal and external conversations. For example, an employee of a company can share all conversations and discussions and/or the messages can be read by all of the people within the same team/company on the social marketplace system after selecting filter ‘coworker’. The social marketplace system can scale from 1 to many employees for each company. In this portion, the information can be seen as a team conversation on the company wall (small amount of people of the same company on the page) or as a company related conversation with all feeds being posted (large amount of people in a company). A user of a company can share company announcements from this location by selecting the privacy filter to his connected business partner by selecting ‘partners’ or posting to a lot more companies who might follow his post by selecting ‘public’ in a scroll down menu before he is posting the message. The message appearing on the company wall coming from coworkers, connected business partners or public posts are marked with a ‘lock’, a symbol for partner-to-partner and a globe icon to illustrate the public nature of a public posted message. If someone or you post directly to your or his partner wall, the message shows up indicated as a private b2b conversation (Debbie Lim of The Gala>Hugo Boss). The company wall also has ‘filters’ to filter down the amount of messages to the relevance. For example you have ‘all’, ‘company’, ‘partner’, ‘transaction’ and ‘Global B2B’ filter to limit the amount of messages to the relevance for more overview.

The system also has a ‘Public’ Posting that is meant for public announcements. This is a filter function where a company can post outside facing content to every users on Balluun who are and who are not connected to this company. A company can use this page primarily for communicating announcements out to potential businesses about:
Events
Product announcements
Inquiries

Posting with privacy filter ‘public’ or ‘Partner’ filter will also display the same feed in ‘company wall’ and ‘your wall’ (if you are the person you have sent the message). The message is also getting marked with the Person's name, the company name and company thumbnail to reference the post to others on their wall. The feed posted public is market as (public).

The amount of feeds being posted on this page can end up to be very large and the social marketplace system may have ‘filters’ on this page to make the information more relevant for a particular employee, etc. For example, the social networking marketplace system may filter feeds/messages based on: 1) filter message posted as Global B2B which means that a user will not see those information by default, but they appear when you press the related filter button; 2) internal conversations only (default); 3) team related conversation (Filter button) for an employee who is part of a particular team; and/or 4) partner Feeds on your Company Wall (Filter).

As described above, the social marketplace system allows a user to attach images and files to the feed on this page as well. This allows, for example, a user to bring files or images to the attention of the audience (coworkers, Partners, public) he is intending to see.

Another function on the Company Wall is that a partner can post messages directly to the Company Wall. Your partner is seeing your Company Wall as Partner Wall and will not see any conversation within his partner company and he will not see a conversation another company was having on your Company Board either.

The system/unit may include a CRM>opportunity portion 150e that first creates an opportunity on the seller side once a buyer was adding products from seller's storefront in his cart. The seller can see what buyer Is planning to buy and can proactively engage. It enables intercompany/participant conversations/communications that may be private business to business object related conversations/communications about a particular opportunity. Once a shopping cart was taken through the checkout and buyer places an order the opportunity disappears automatically and converts into an order for seller under manage orders. Seller can there manage the order he received from buyer. Within the order details seller can get in touch with buyer to communicate with him related to the order (object). The system/unit also may include a Orders>manage order portion 150h that enables inter-company/participant conversations/communications that may be private business to business object related conversations/communications about the management of an order that is being managed using the manage order system of the marketplace.

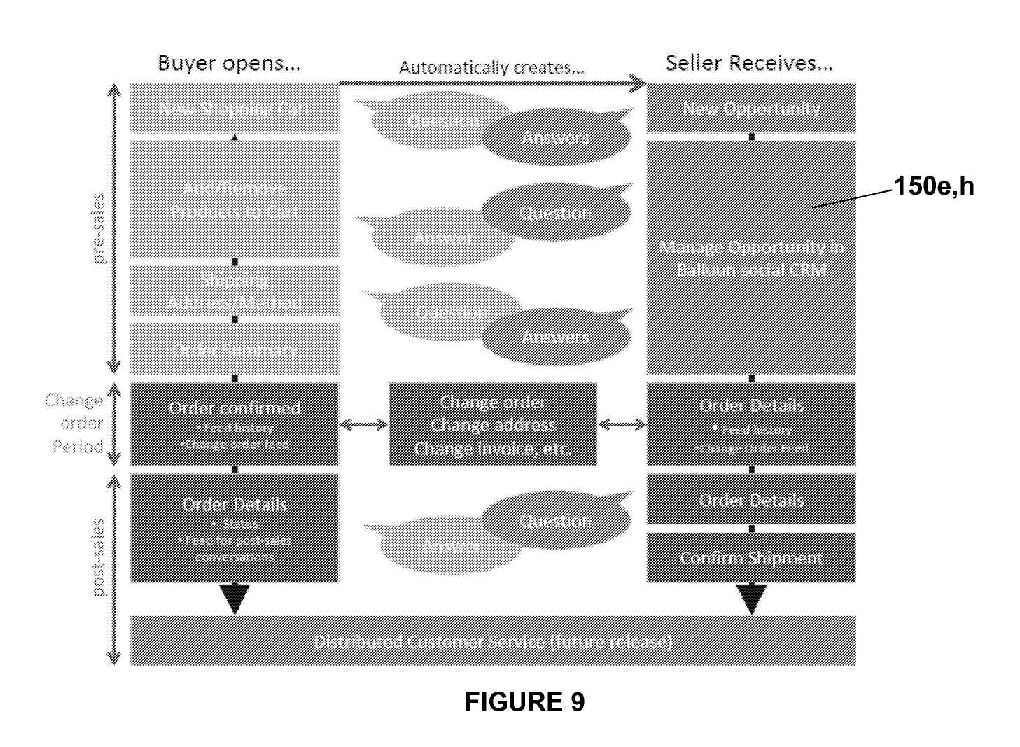

FIG. 9 illustrates various social e-commerce aspects of the social business to business (B2B) marketplace that includes the social CRM/opportunity portion 150e, h of the social business to business (B2B) marketplace. In particular, as soon as a buyer is adding products of his suppliers storefront into his shopping cart, the social marketplace system not only adds a social feed to the shopping cart but also creates an opportunity and an opportunity related social feed in the sellers Opportunity Management Tool. The identity (ID) of the opportunity and the shopping cart are related and the social feed of both the Opportunity and shopping cart are connected for a ‘social’ CRM experience. Then, the seller can start a conversation with the interested buyer or respond to questions the buyers is having during his shopping tour. After the buyer submits the order, the Opportunity is automatically closed within the Opportunity Tool and moved into the Manage Order part. Under a Manage Orders tab, a seller can get access to the purchase orders of his/her buyers. When he accesses a particular order, the seller can manage shipping information and change status to paid, shipped, etc. Within the Order Overview, the seller also finds the social feed related to the order and the seller can review conversations related to this Opportunity (pre-sales) and Order (post-sales). The user can also start more communication related conversations to the order based on the same social feed structure.

From there the buyer is able to look into the conversation trail related to this Opportunity as well as can have additional conversations about this order with his buyer about post-sales activities like shipping status, customer service, etc. Transaction related conversation are also showing up in company wall attached with the transaction ID for a user to easily identify a transaction related conversation in the company wall (seller and buyer). The transaction filter on company wall also allows to filter after all transaction related conversations.

As soon as a buyer is adding products of his suppliers storefront into a cart, he is creating a shopping cart with that seller and the system not only adds a social feed to the shopping cart but also creates an opportunity and an opportunity related social feed in sellers Opportunity Management Tool. A transaction ID of the Opportunity and the shopping cart are related/same and the social feed of both the Opportunity and shopping cart are connected for a social CRM experience (private Buyer/Seller conversation) so that the seller can start a conversation with the interested buyer or respond to questions the buyers was asking while purchasing. After the buyer is submitting the order the Opportunity is automatically closed within the Opportunity Tool and moved into the Manage Order part as a Purchase Order. From there the seller is able to look into the conversation trail related to the Order as well as can have additional conversations about this transaction with buyer about post-sales activities (shipping status, customer service, etc.)

The Orders>Manage Order portion 150h allows a seller to get access to the placed orders of his buyers. When the seller gets into the Order, the seller can manage shipping information and change shipping status and if payment is received (if not recognized automatically by the integrated payment system), etc. Within the Order, the seller can also contact buyer through social feed related to this order so that the seller can review conversations related to this Opportunity (pre-sales) and Order (post-sales). The structure allows seller but also buyer to review the whole conversation trail related to this order from start to end.

In the system, each company has partnership between one or more companies may have their own areas of the storefronts that may be known as MyPartners storefronts. In the MyPartners portion of the marketplace, where each connected partner is accessible by company to go to their Partner Wall, Employee Walls of the partner or even Storefront if available. Each partners may further have a partner Wall portion 150i that enables inter company/participant conversations/communications that may be private business to business conversations/communications. The MyPartner portion also may have an employee profile portion 150j that enables inter-company/participant conversations/communications that may be private personal business to business communications. Through the connection company can visit partners profile and storefront and that's where the user would go to start buying product from partners storefront.

The seller company account on Balluun is able to create a social storefront. The storefront is accessible to display products to interested business partners. But since it's a social network related marketplace, the seller and buyer have to connect to be able to conduct business with each other. Only when a connection request is made the connection will enable buyer to see sellers pricing information and with that he is able to create a shopping cart with seller. Seller has inventory management tool and add product tools to create storefront. Since storefront is seller's own storefront under company account seller is required to connect his storefront with a PayPal account to be able to receive funds. He is also required to enter his own terms of sales since buyer will have to accept sellers terms of sales in the checkout. Seller will also have to define shipping cost using the system's shipping cost module which will allocate the predefined relational shipping cost to the cart when buyer is taking sellers product through checkout. Seller can also determine if products should stay in inventory management without displaying, if products should only be visible to connected business partners or if products should even be displayed on Balluun marketplace, which is the place where all public products are shown in random order separated in industry categories.

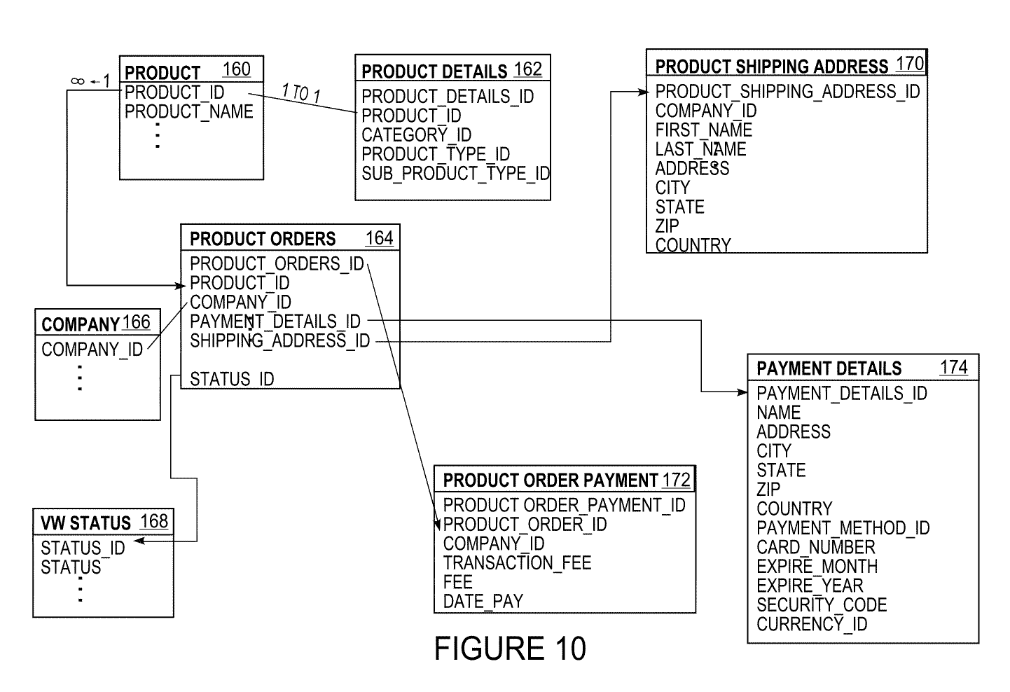

FIG. 10 illustrates an example of a database schema the enables the e-commerce and CRM portions of the social business to business (B2B) marketplace. It should be understood that the marketplace system may use other database schemas that are within the scope of the disclosure and the example in FIG. 10 for illustration purposes only. In the example shown in FIG. 10, a relational database is used with a plurality of database records that have relationships with each other. For example, the database schema may include a product data record 160, a product details record 162, a product orders record 164, a company record 166, a status record 168, a product shipping address record 170, a product order payment record 172 and a payment details record 174 that are related to each other as shown in FIG. 10 to enable the e-commerce, storefront and CRM portions of the social business to business (B2B) marketplace.

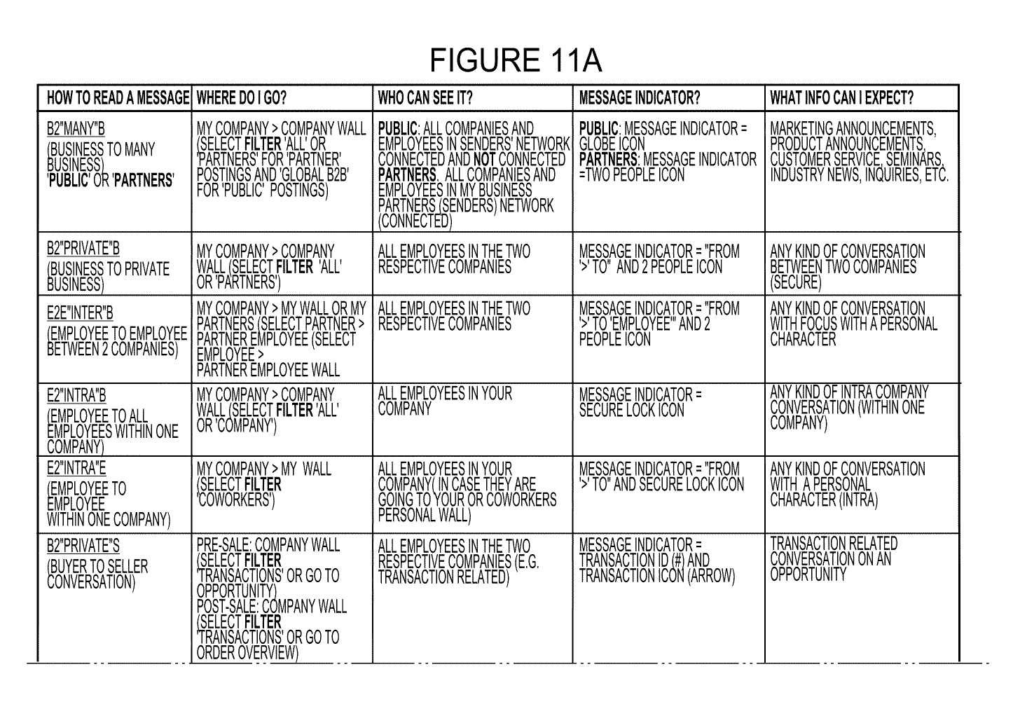

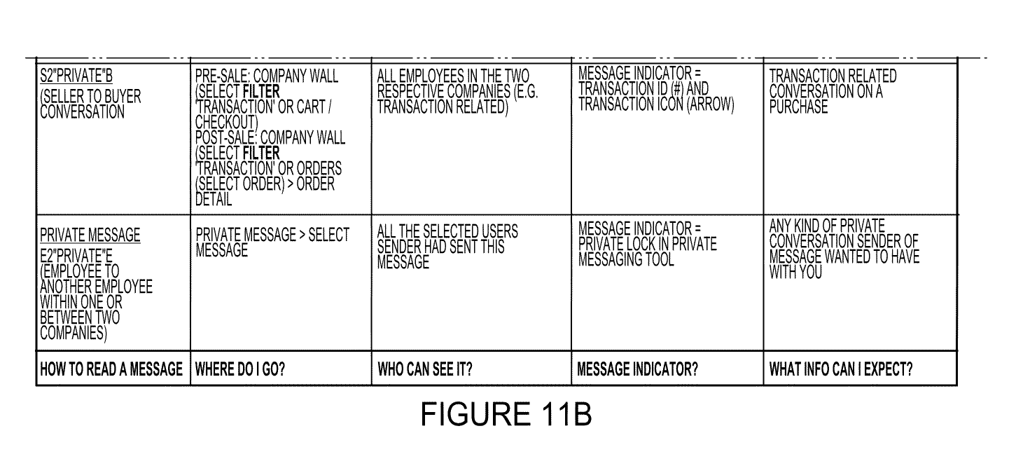

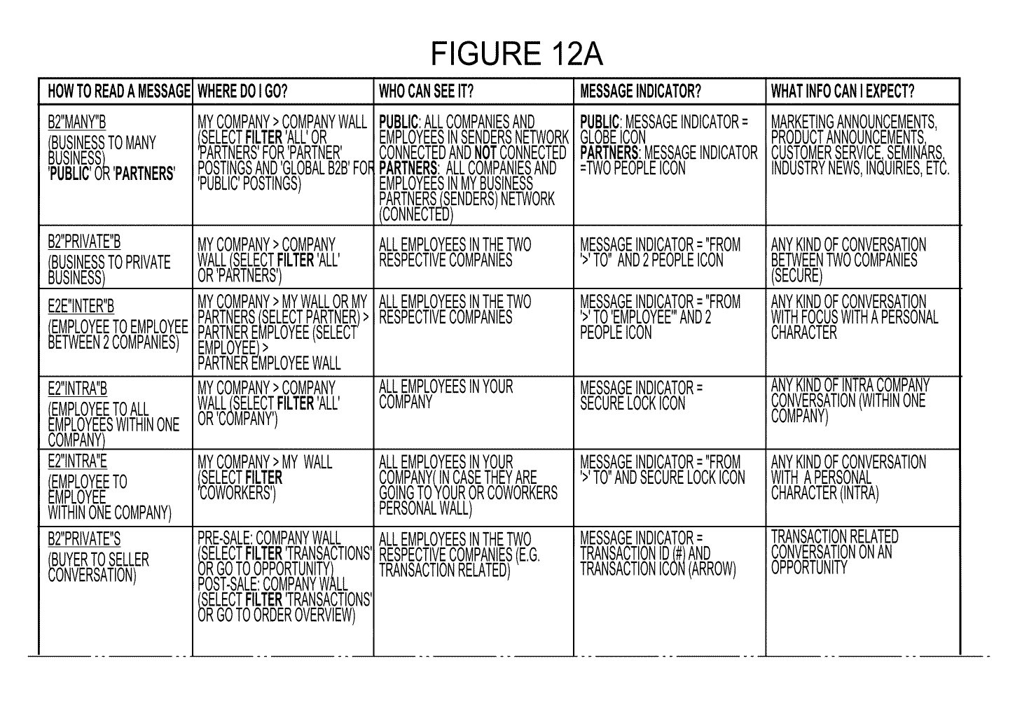

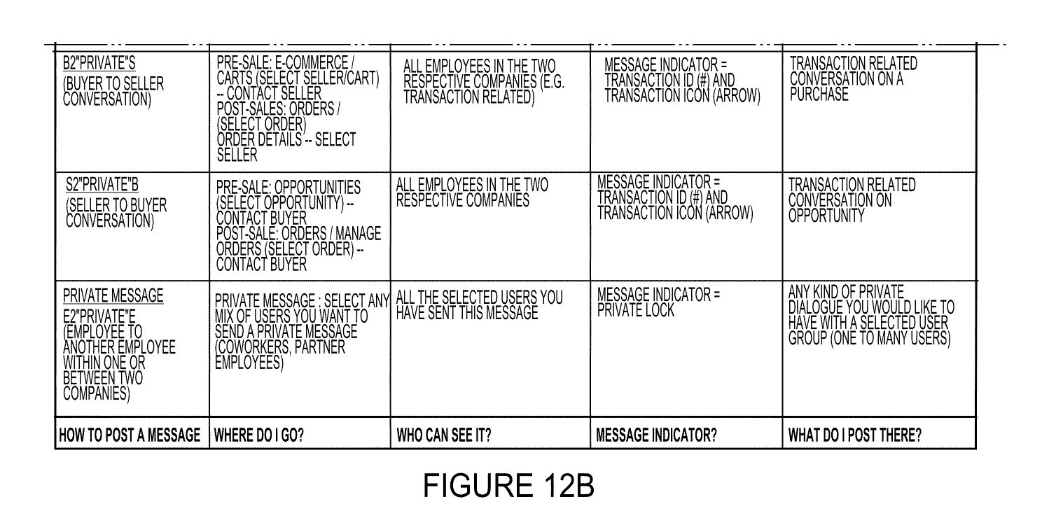

FIGS. 11 and 12 are a consolidated list of different ways to read/post a message in the social business to business (B2B) marketplace. In particular, the list show the different types of communications (business to many business, etc.), where in the social B2B marketplace system the user can post/read messages for that type of communication, which other users/participants can view that communication (based on privacy/security settings of the social B2B marketplace system) and what type of information can be communicated using the particular type of communications.

FIG. 13 is a list of different activity streams in the social business to business (B2B) marketplace. The activity streams are generated when certain action occurs in the social business to business (B2B) marketplace. For example, as shown in FIG. 13, when a new company joins the social business to business (B2B) marketplace, an activity stream is generated that has the characteristics shown in FIG. 13. Similarly, when a user joins a company that is part of the social business to business (B2B) marketplace system, an activity stream is generated; when a company uploads new product to their storefront (for co-workers); when the company uploads new product to their storefront (for partners); when the company uploads new product to their storefront (for the public) and when the company has a new connection to another company all generate activity streams that appear at different places (see where does it show column), to different people (see who can see it column), have a particular message indicator (see message indicator column) and have a different use to the users.

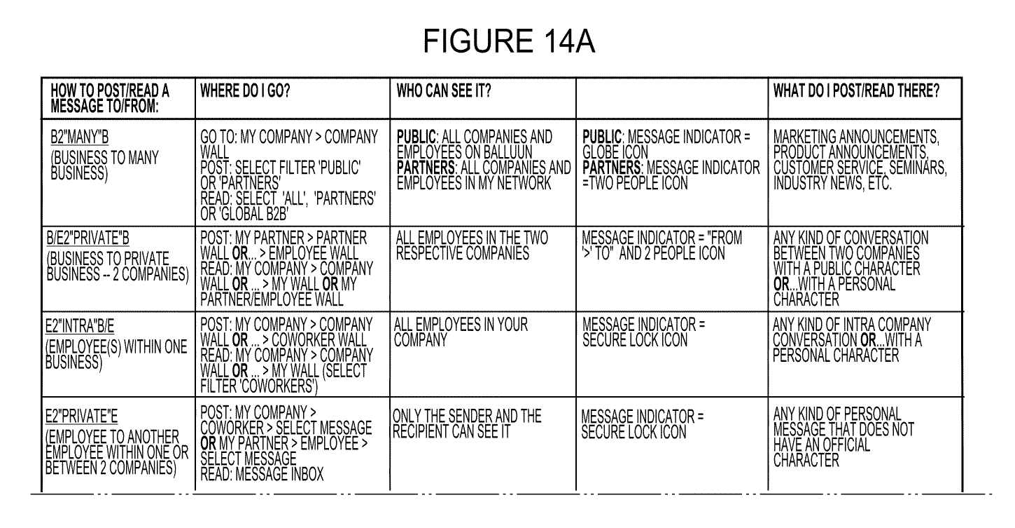

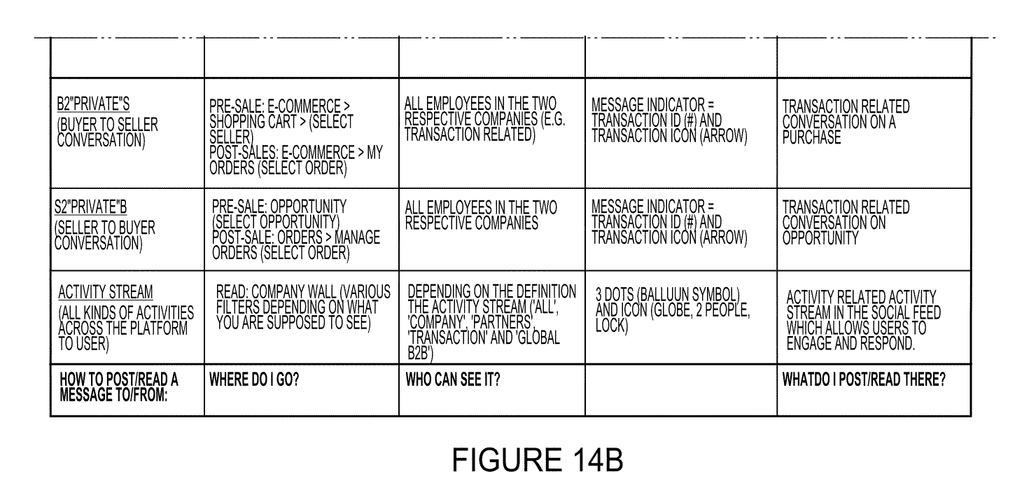

FIG. 14 is a list of different ways to read/post a message (including activity streams) in the social business to business (B2B) marketplace. The types of messages may include messages to/from B 2 many B, B/Es”private B messages, E“intra” B/E messages, E2“private”E messages, B2“private”B messages and activity streams that appear in different portions of the system (see when do I go column), appear for different users (see who can see it column), have different message indicators and have different purposes.

In summary, the social B2B marketplace system may have a social network module/unit, a seller store front unit (B2B only), a shopping cart unit (B2B only), an order management unit and a payment management unit that can take advantage of the social feeds that were described above. The seller store front (which is available to each seller participant (company) of the social B2B marketplace system), allows the seller to sell one or more products/services wherein a buyer can create shopping carts with several sellers and can submit one or more orders that are fed from the shopping cart unit. The shopping cart unit may store an order list and shipping. The system may integrate with a commercial payment system, such as PayPal's marketplace API application, through which a user can make payments where funds flow directly to seller's Paypal account which is connected to the Balluun storefront. As part of the payment, Ballun (the company that hosts the B2B social marketplace system) may receive a small portion of the payment that may be wired directly into Balluun's Paypal account for the services provided. The social network module is related to shopping cart module so that, when a buyer places an order in the shopping card and has any question, the seller and buyer can communicate with each other via social network unit as described above. The shopping Cart module and Order Management module is related each other so that, when a buyer places an order in shopping cart module, the order management will get the information to process the order. In the system, payment information is not saved in the payment module since, as soon as an order is placed, the buyer can decide to pay later or pay with PayPal or a credit card. The user can click on a pay now button and will be re-directed to PayPal's payment system for payment. Once payment is made, the buyer is redirected to a Balluun confirmation page and both the seller and buyer are getting a confirmation that payment have been made or received. In addition, the status of order is changing from unpaid to ‘paid’ visible to seller and buyer in orders tool.

The social B2B marketplace system may further comprise a filtering capability. In particular, since the unified database has the social feed all on one place, the system is able to filter messages to the place a message was entered and the place where they are displayed. The Balluun website has two different types of the account. One is for seller and the other one is for buyer. The way to define these two different types of the account is on the sign up form. When user registers an account, user will need to select “Buy” or “Sell”.

The social feed is one of the major functions in Balluun website. In Balluun website, there feeds are “Home”, “MyCompany” and “MyPartners”. The way to distinguish for all these different purposes is using “message type” to filter out all different purposes. The message type may include Partner Public, Internal Public, Employee himself, Employee other, Partner to Partner, Partner Employee to Partner Employee, opportunity and order processing. All these message type will be based on the purpose to apply all different ways of social feed.

In one embodiment, the system has multiple places to enter messages related to the place on the marketplace (Company wall with privacy filter ‘coworkers’, ‘partners’ and ‘public’ for company internal posting (coworkers) and b2manyb conversations (parters) and public postings (public); MyProfile=My postings on my own profile page (wall); partner employees or co-worker profile page (wall)=message dedicated to this person; transaction related posting and activity streams places {shopping cart, opportunity, manage order, my orders}. The places of visibility are on those places, too, but also can show up on other places as required depending on the filter settings.

The system may have, for example, a number of filter choices on Company wall and a number on my wall a user is getting on a given social page just to tune the content to the relevant message required to structure his work tasks as shown in the table below.

My Company Wall

| | |
|---|---|
| Filter: All | Combine: Company, Partners, Transaction and Global |
| | B2B filters |
| Filter: Company | Messages between all co-workers |
| | Messages between partners |
| | All opportunity messages |
| | All transaction messages |
| | All public messages (Global B2B Messages) |
| Filter: Partners: | Messages between partners |
| | All public messages (Global B2B Messages) |
| | All opportunity messages |
| | All transaction messages |
| Filter: Transaction | All opportunity messages |
| | All transaction messages |
| Filter: Global B2B | All public messages (Global B2B Messages) |

My Wall

| | |
|---|---|
| Filter: My Posts | All messages which are posted ore replied by user. |
| Filter: Co-Worker | |
| Filter: Partners | Partner type messages which are posted or replied by |
| | user |
| Filter: B2B Wall | Global type messages which are posted or replied by |
| | user |

Partner Wall

Partner, opportunity, transaction type messages which
show to the connected partners

Partner Employee Wall

Message which is between two company's workers.
(Ex. Company A's Sales to company B's Buyer)

Co-Worker Wall

Message which is between co-worker who posts or
replies the message.

FIG. 15 illustrates an example of the filtering of ‘public’, ‘partners’ and ‘coworkers’ posting on MyCompany portions of the social business to business (B2B) marketplace and FIG. 16 illustrates an example of the filtering for the MyPartners portion of the social business to business (B2B) marketplace. The social B2B marketplace system may have basically two different types of accounts where one account is a seller account and the other account is a buyer account. The way to define these two different types of the account is on the sign-up form. For example, when a user registers an account, the user will need to select a business type (manufacturer, brand, wholesaler, retailer, etc.) and balluun associates a seller or buyer function to the business type and the system will use this to determine if the new account is a “Buyer” account or a “Seller” account. A future enhancement might lead to have a user to create independent from the type of account buyer or seller, but what he is start doing on Balluun. Is he creating a storefront then he will get the seller status. Is he not, then he will stay in a buyer status. (buyer status has a slightly reduced set of functions focused on the collaboration need, but exclusive the seller functions). As described above, the social feed is one of the major functions of the system that is implemented in the (we removed ‘home’) “MyCompany”, (“myWall”, “Coworker Wall”) “MyPartners” portions (which includes “Partner Employee Wall”, shopping cart/opportunity related feed). The way to distinguish for all these different purposes is using “message type” and “activity stream type” to filter out the different purposes for the message. In the system, the message type may be Partners, Public, Internal, Employee himself, Employee other, Partner to Partner, Partner Employee to Partner Employee, opportunity and order processing. All these message type will base on the purpose to apply all different ways of social feed and activity stream. FIGS. 15 and 16 show the filters applied and the type of messages that are seen in each portion of the system based on the filtering.

Additional Examples of the User Interface of the System

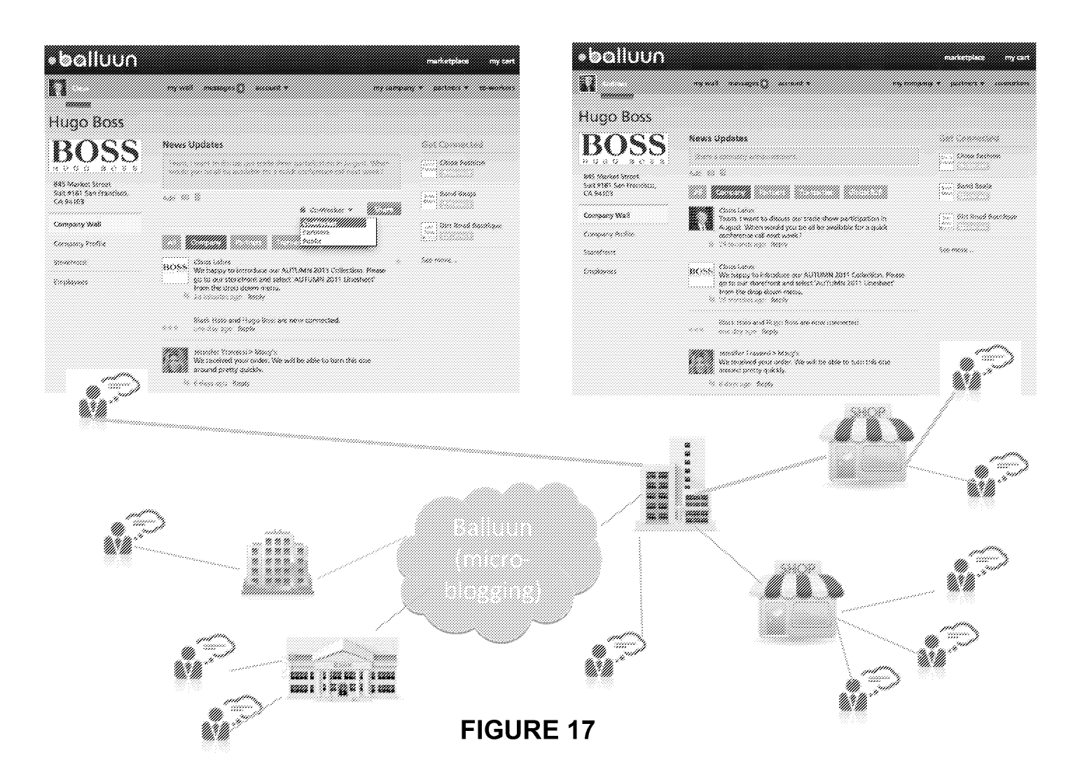

FIG. 17 illustrates an example of a Company Wall with a privacy filter setting of coworker of the social business to business (B2B) marketplace. A posting on the Company Wall with privacy filter settings ‘coworker’ is meant for company internal conversations. Here and with this privacy selection (coworker) an employee of a company on the social business to business (B2B) marketplace system can share all conversations and discussions within the company. Here the messages can be read by all of the people within the same team/company on the social business to business (B2B) marketplace system. The system can scale from 1 to many employees. The information can be seen as a team conversation on Company Wall (small amount of people of the same company on the balluun wall) or as a company related conversation with all feeds being posted (large amount of people in a company on the system). The amount of feeds being posted on this page can end up to be very large and the system introduced ‘filter’ to filter the information based on categories.

Filter:
All (This filter is showing all messages related to your company if internally or to your connected business partners.
Company (all internal Conversations)
Partners (all partner related conversations: 1. B to many B posting 2. private B2B conversations)
Transaction (all transaction related conversations coming from checkout, opportunity or order management
Global B2B (Public) are all postings set with privacy filter ‘public’ —all companies can follow this conversation

Since adding an image or a file to the feed is possible (rich media feed), it also allows to send collateral to business partners or interested companies in a mass marketing initiative. The company wall is the place for company internal conversations but it is also the place where your connected business partners posts come in to you. Your partner is seeing your Company Wall as Partner Wall. He will not see any conversation within his partners company and he will not see a conversation another company is having on your Partner Wall either.

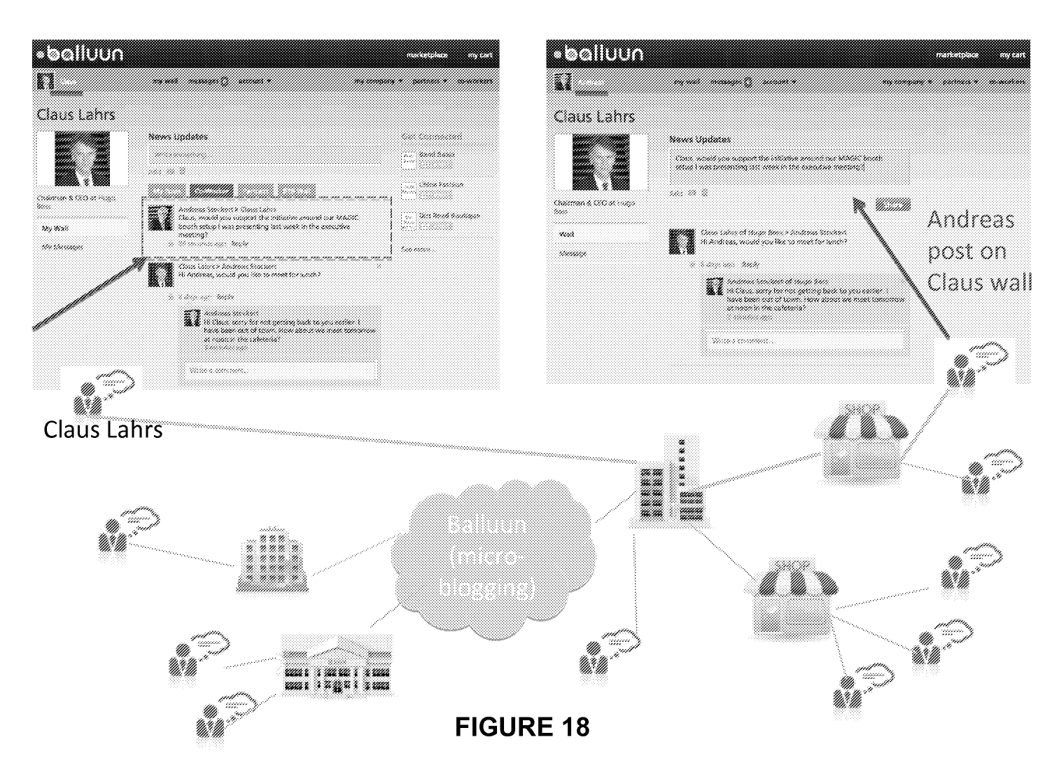

FIG. 18 illustrates an example of a my coworker wall of the social business to business (B2B) marketplace. A posting on coworkers direct wall is meant for a Person to Person conversations. With sharing on someone's wall, a user can initiate a direct conversation with his coworker directly on his wall. The message is marked as ‘Claus Lahrs’ to ‘Andreas Stockert’ and even other coworker can see this post (for example by going to one of their coworkers wall, they can either follow this conversation or get engaged and add a ‘comment’ to the feed. Since this is a coworker to coworker post this message is not visible to other companies. Since adding an image or a file to the feed is possible (rich media feed), it also allows to send collateral to business partners or interested companies in a mass marketing initiative.

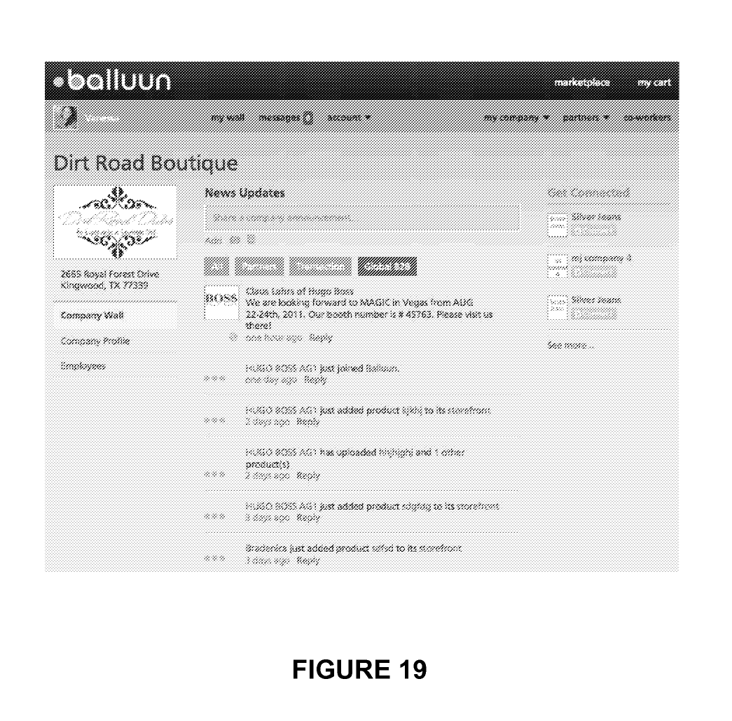

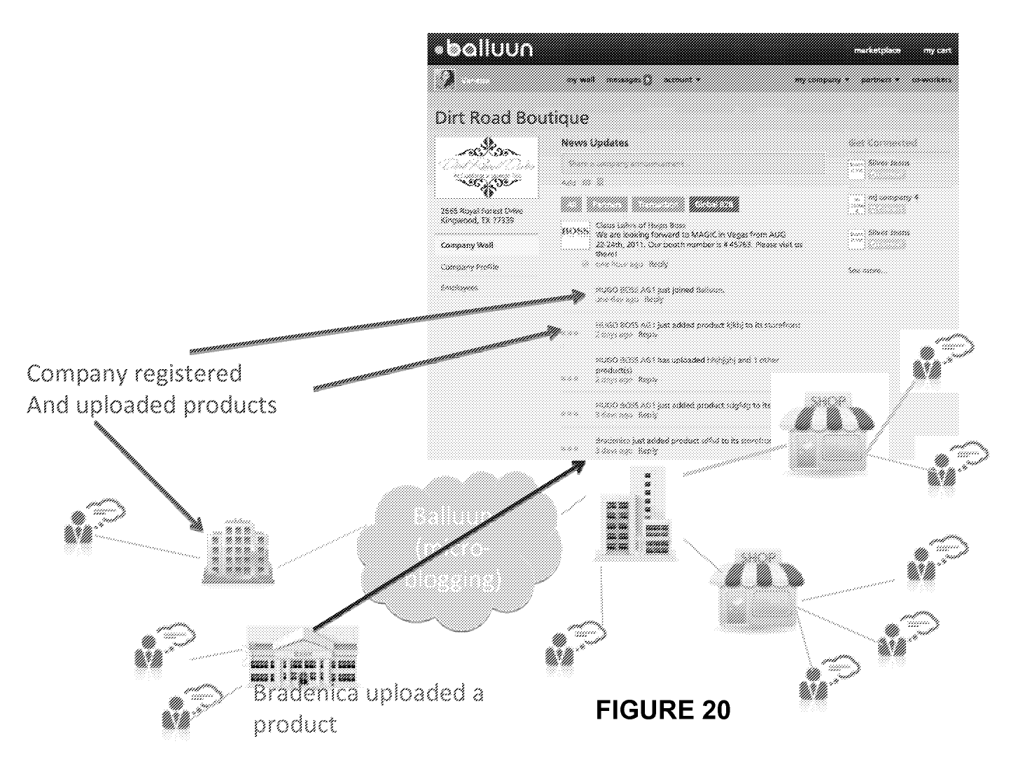

FIGS. 19-20 illustrates examples of activity streams of the social business to business (B2B) marketplace. As described above activity streams can be multi-level because they can appear based on activity privacy to a company internal audience, related to page relevance, more open to connected business partner when it is beneficial that they should learn about the activity the business partner is doing OR when an activity could be beneficial for discovery even for not connected companies it can also show up in Global B2B. FIG. 19 illustrates a user interface with an example of a user interface with a list of activity streams (in the form of news updates.) FIG. 20 shows how those activity streams in FIG. 19 are generated based on activities of the social business to business (B2B) marketplace system.

FIG. 21 illustrates an example of the private messaging provided by the social business to business (B2B) marketplace. The private messaging allows a user to send one or more private messages between any connected person within a company and/or between companies and provides a complete private utility to share private messages between 2 users in a given network or between more then 2 users in a group messaging structure. The private messaging is available based on the same connectivity process the social feed structure was set up. User can go to a user wall and press the ‘Message’ tab and will get to the private message pop-up which allows the user to enter a message to that person (one on one) but just private (no one else can see this message then this 2 users or user is going to message section of the application enters ‘New Message’ and enters the people he wants to send the message. The available users in his network (and only those) will be available to select. As shown in FIG. 21, the system provides private one-to-one messages (from Strellson to an employee of Macy's) as well as private group messages initiated by one person (an employee at The Gala) to several other people (employees at Strellson and Hugo Boss) who can maintain the private conversation in group style.

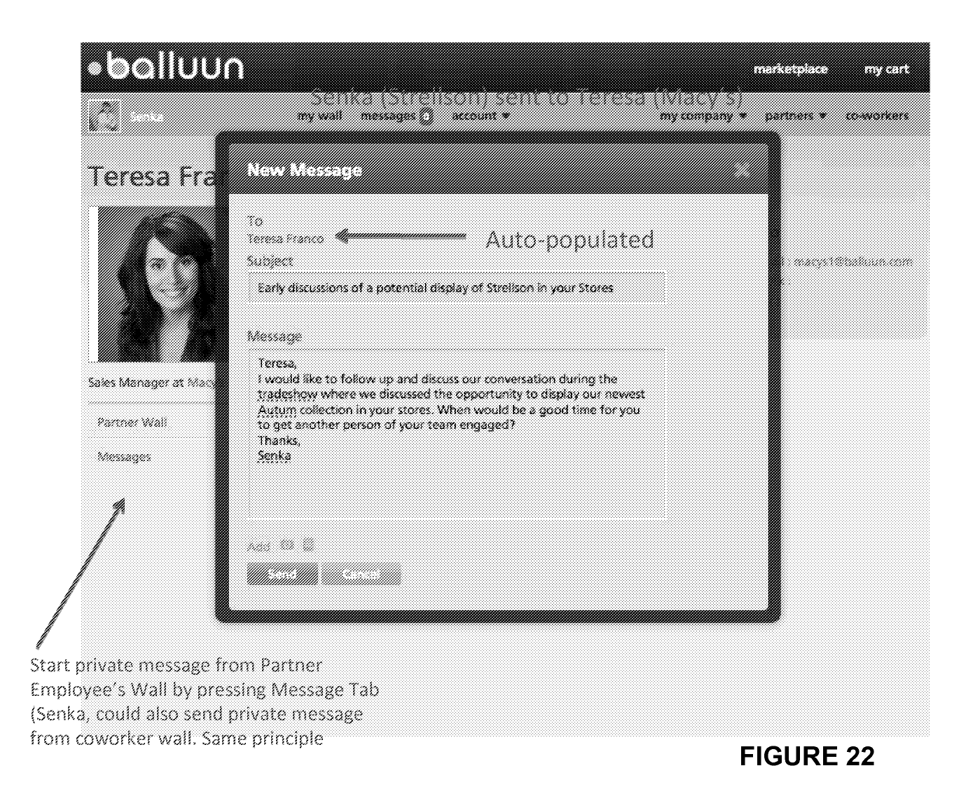

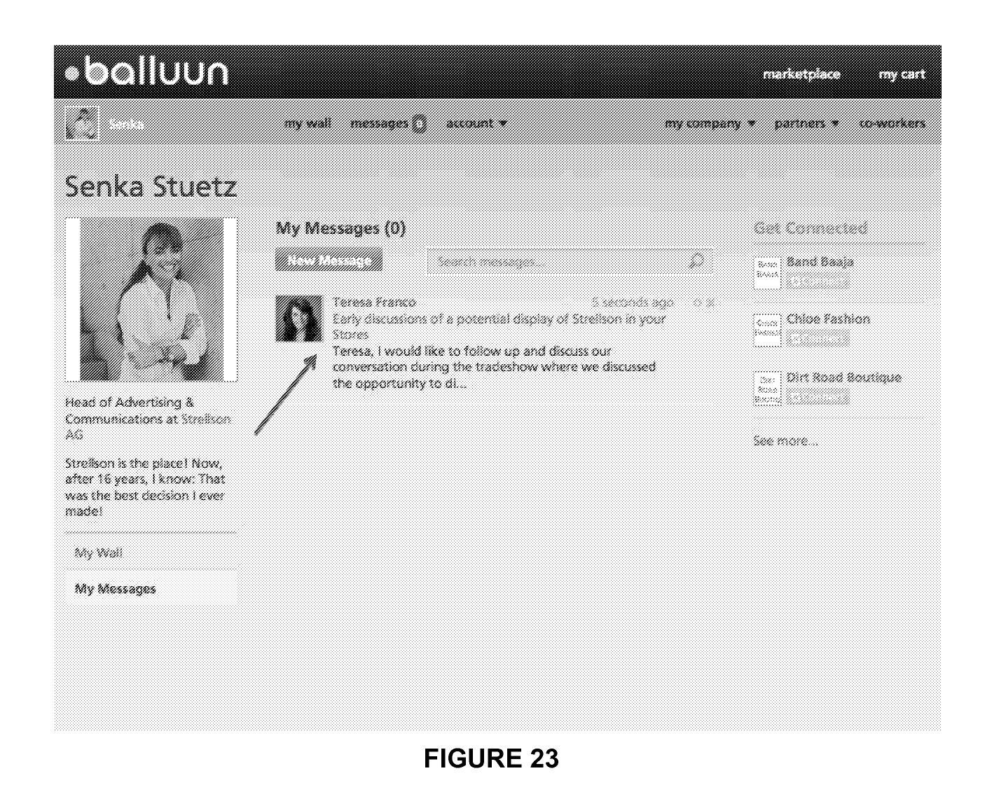

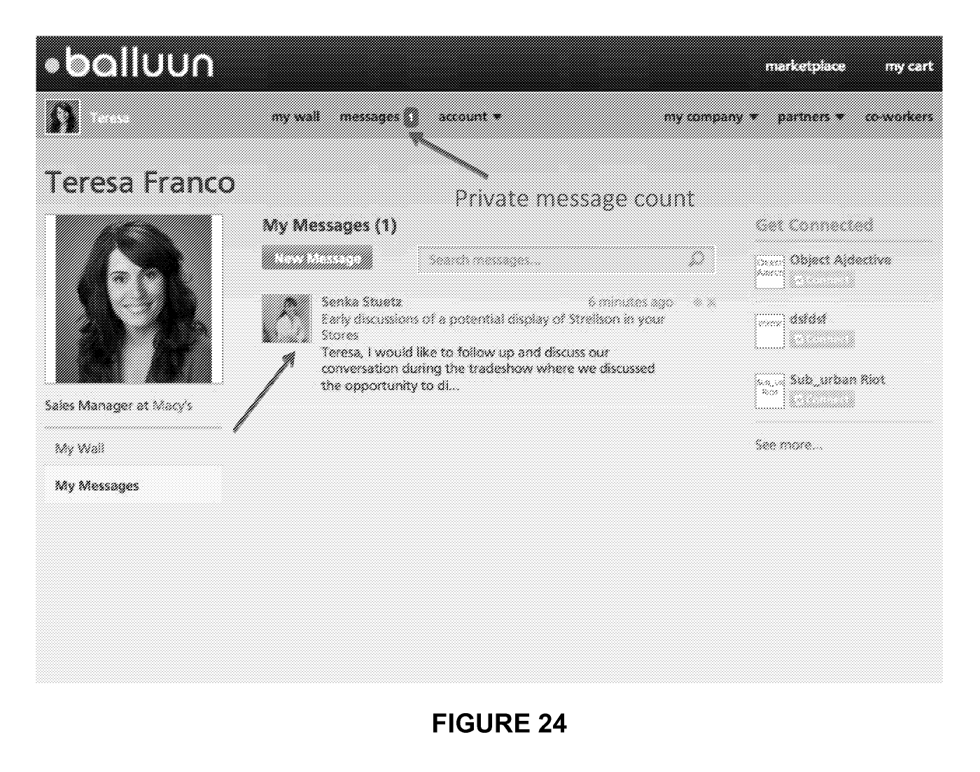

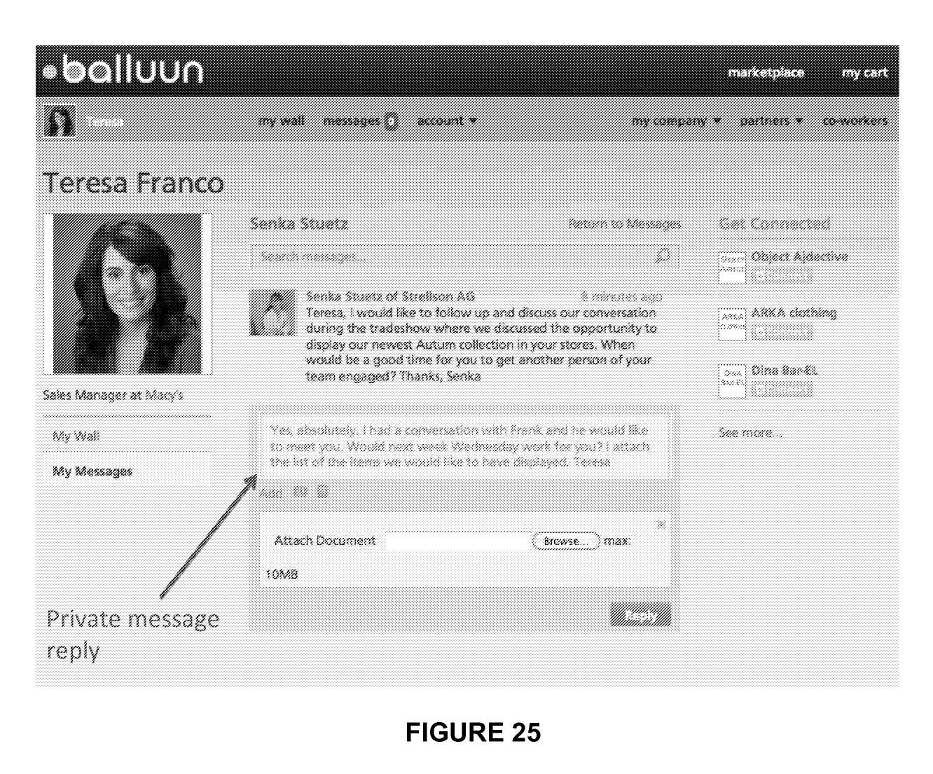

FIG. 22 illustrates an example of a private one-to-one message conversation that is provided by the social business to business (B2B) marketplace. As shown, for a new message as shown in FIG. 22, the new message pop-up window occurs and the address is auto-populated. The user can start a private message from a partner employee's wall by pressing a Message Tab, such as to Senka. FIGS. 23 and 24 illustrate examples of the user interface of a private messaging tool for Senka and Terera with examples of the messages between the two people. Furthermore, FIG. 25 illustrates a user interface of the private conversation between two people using the social business to business (B2B) marketplace in which a reply stays private.

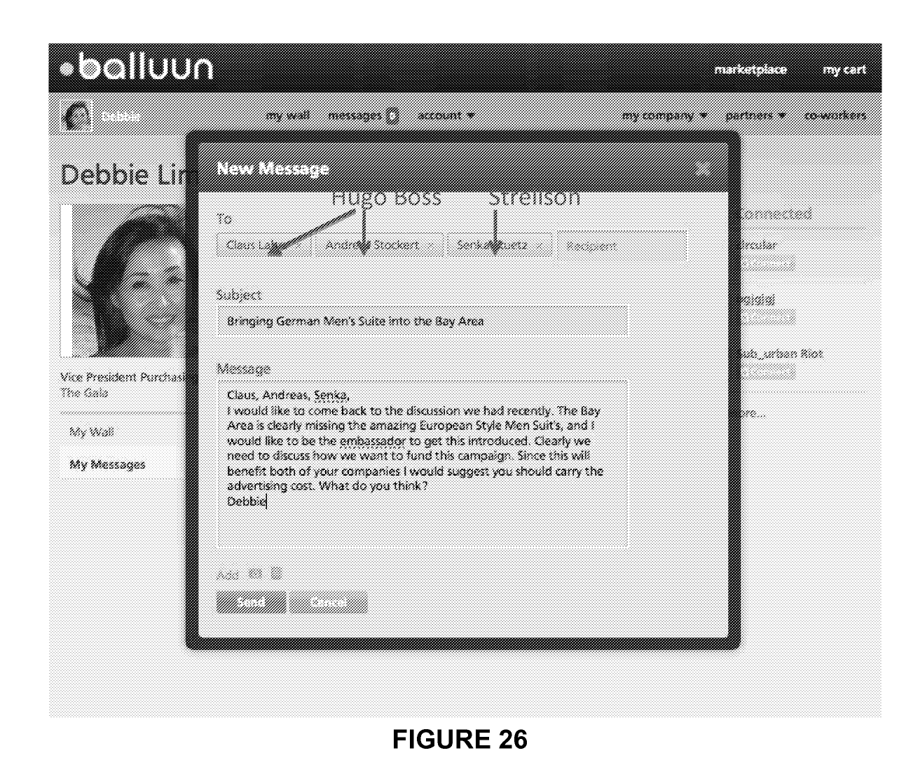

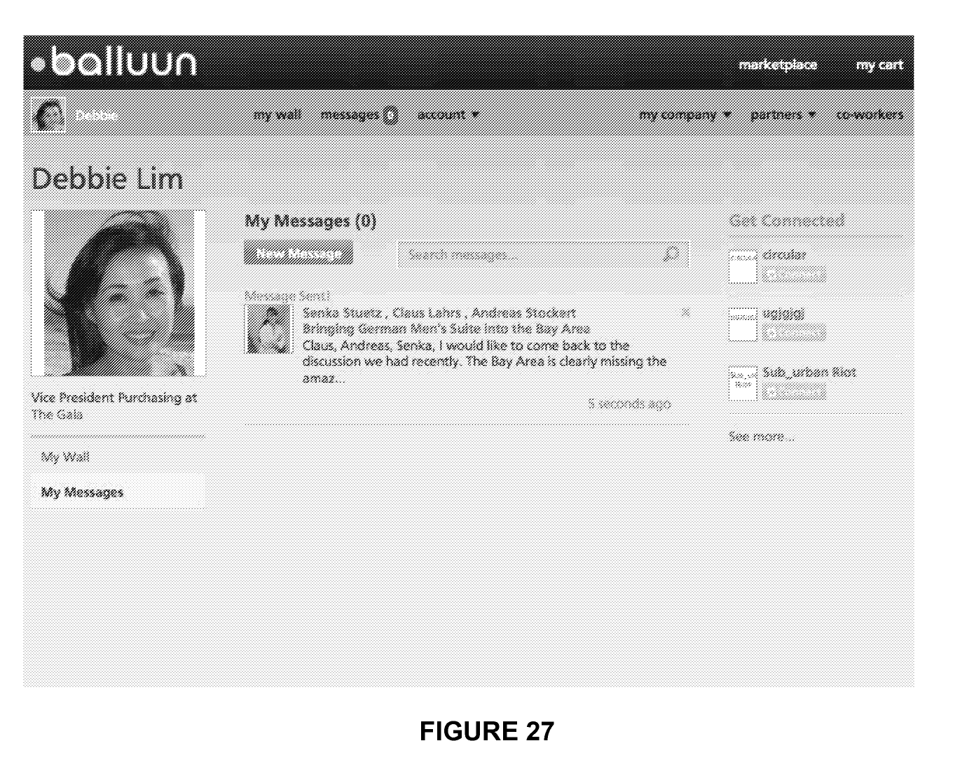

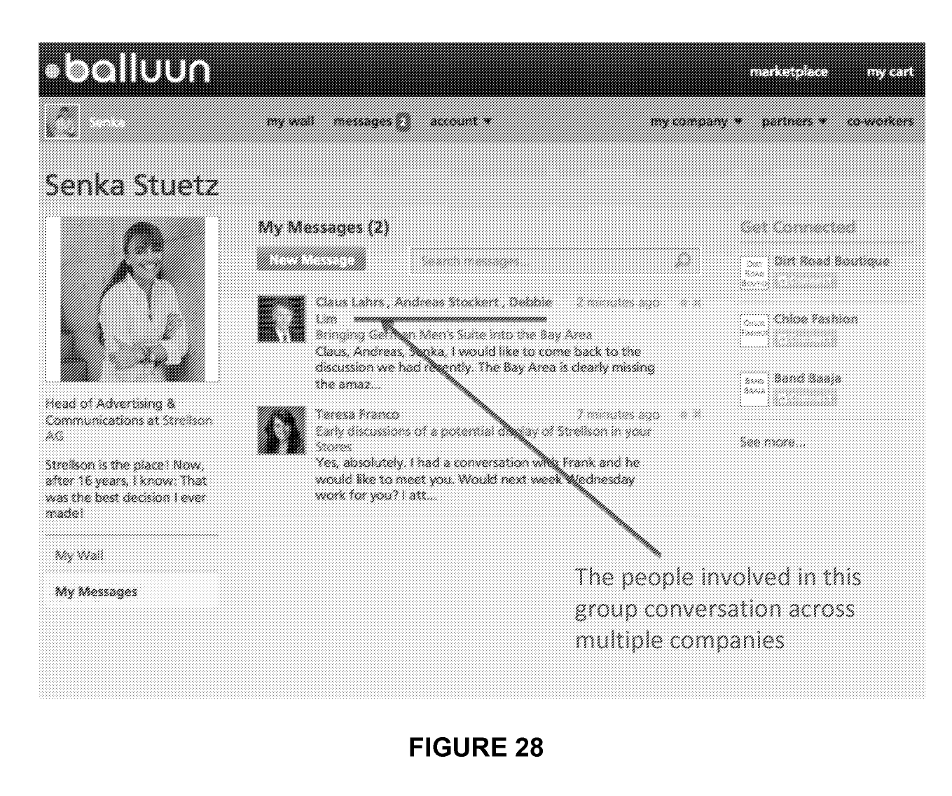

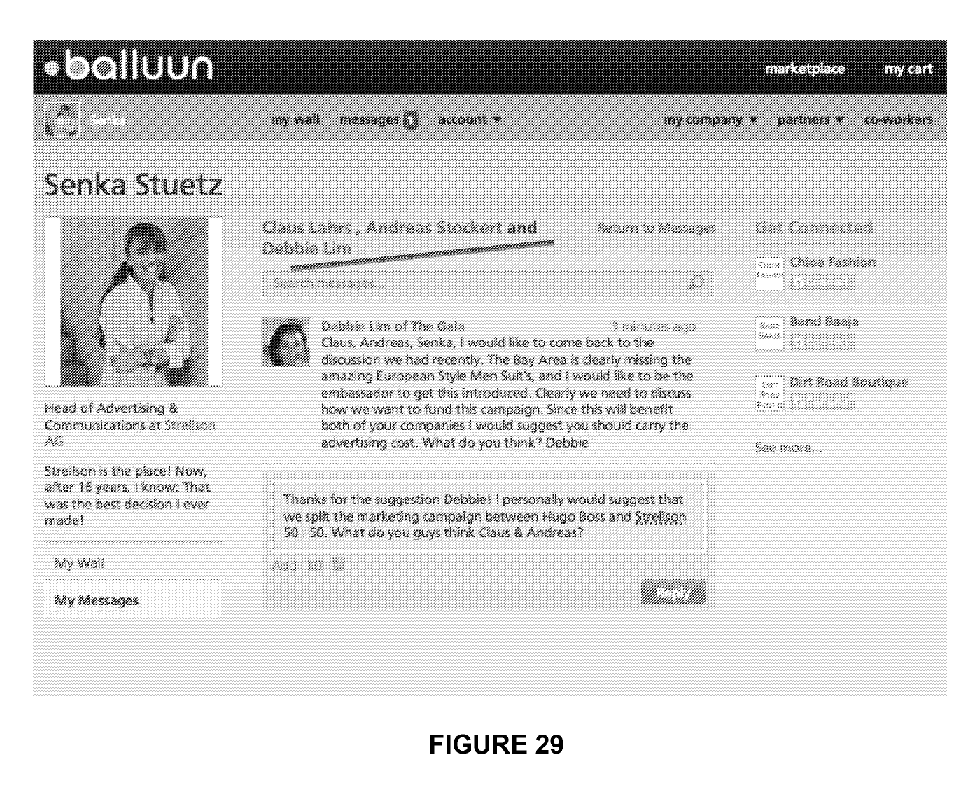

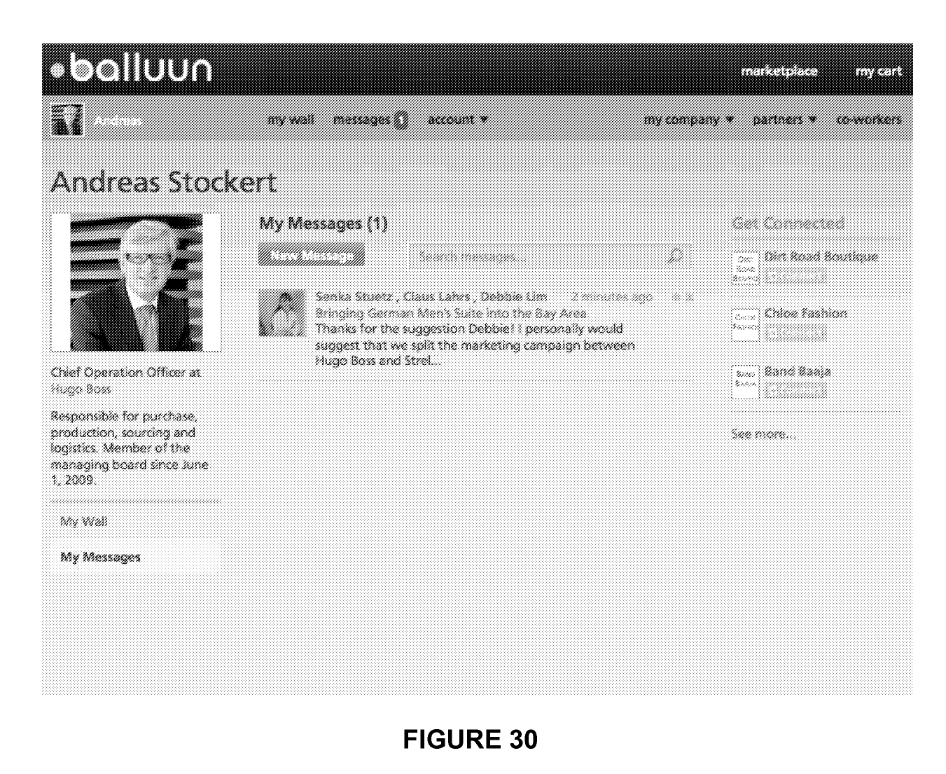

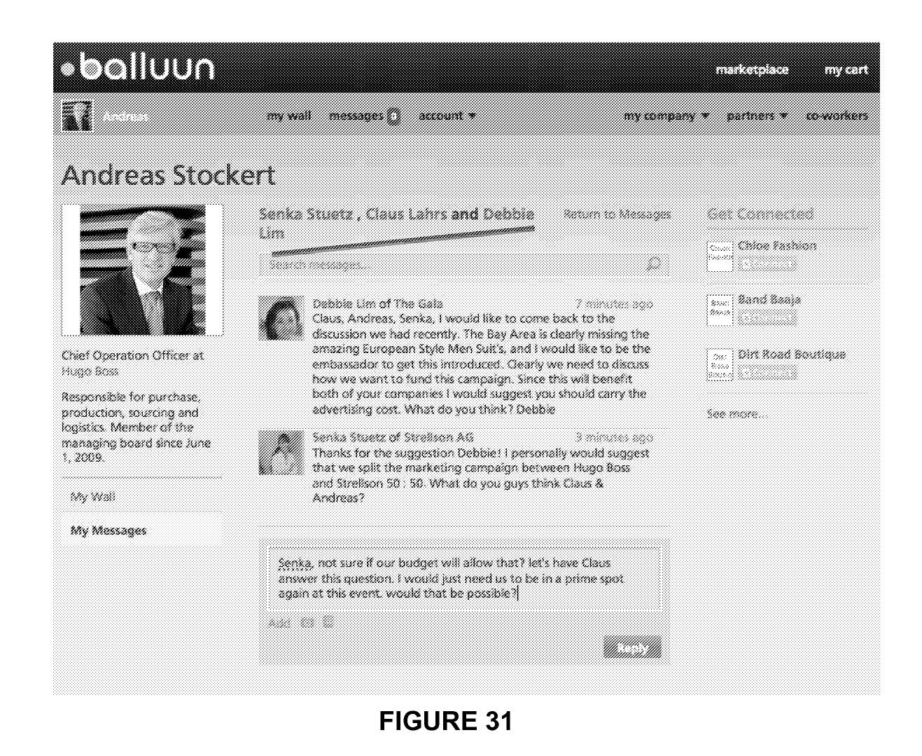

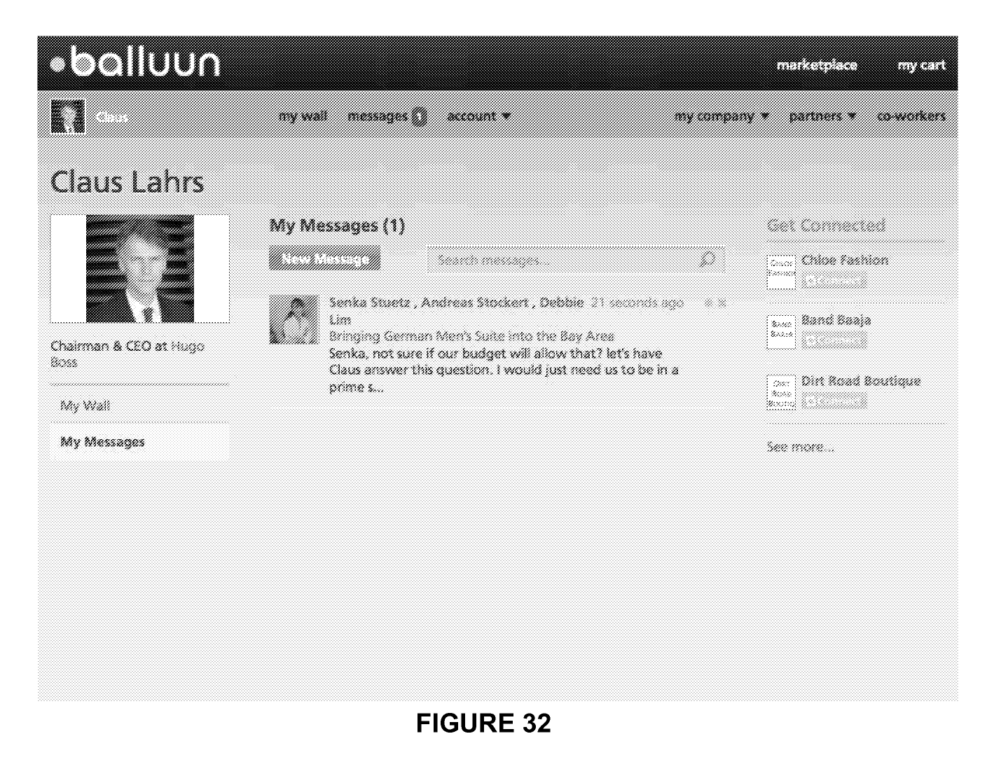

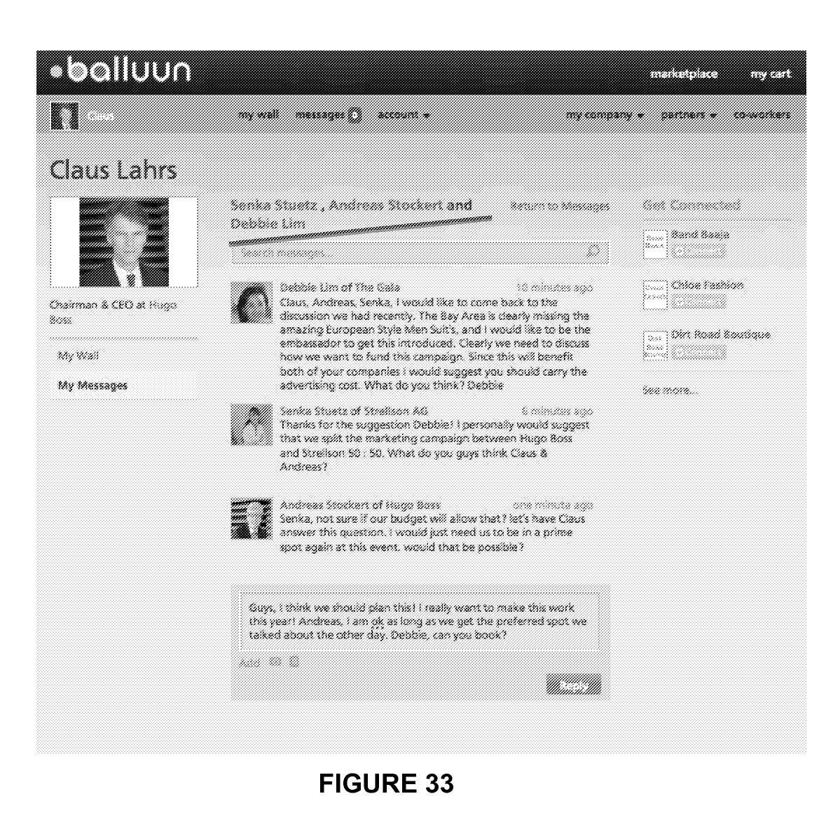

FIG. 26 illustrates a user interface of the private group conversation using the social business to business (B2B) marketplace. As shown in FIG. 26, using a new group message window, a user can start a private group message to connected companies (a three person group message is shown in FIG. 26). FIG. 27 illustrates a user interface of the private messages between business partners using the social business to business (B2B) marketplace. FIG. 28 illustrates a user interface of a message received status for a private message using the social business to business (B2B) marketplace. FIG. 29 illustrates a user interface of a comment to a private message using the social business to business (B2B) marketplace. FIG. 30 illustrates a user interface of a message received status for a private message using the social business to business (B2B) marketplace. FIG. 31 illustrates a user interface of another comment to a private message using the social business to business (B2B) marketplace. FIG. 32 illustrates a user interface of a third person who received a private message of the social business to business (B2B) marketplace. FIG. 33 illustrates a user interface of another comment to a private message using the social business to business (B2B) marketplace.

Returning to the social shopping cart and checkout of the system that may impose transaction related fee structure based on: social shopping cart; social checkout; social CRM/Opportunity; social Manage Order; social MyOrders and social Customer Service based on the integration of micro-blogging into the transaction based service on the system.

While the foregoing has been with reference to a particular embodiment of the invention, it will be appreciated by those skilled in the art that changes in this embodiment may be made without departing from the principles and spirit of the disclosure, the scope of which is defined by the appended claims.

1. A social business to business marketplace system, comprising:
a marketplace for at least one seller and at least one buyer, the marketplace having a store front for each seller, a shopping cart for each buyer at each the storefront for each seller, an order management unit that manages orders submitted using the shopping cart and a payment management unit that manages the payment for orders to facilitate a transaction between a buyer and a seller who are users of the marketplace;
a social feed system, integrated into the marketplace, that provides one or more of company walls, employee walls, partner walls and private messaging and generates an opportunity social feed to the seller when an item is placed into the shopping cart by a buyer; generates a order management social feed to the seller when the buyer submits a completed order and generates a purchase social feed to the seller; and
wherein the opportunity social feed, the order management social feed and the purchase social feed permit the buyer and seller to sends feeds to each other during the transaction.

2. The system of claim 1 further comprising a third party API for processing a payment transaction.

3. The system of claim 1 further comprising a recommendation engine to help companies to invite a second company to the social business to business marketplace system.

4. The system of claim 1, wherein each buyer is a company and the company has one or more employees that are users of the marketplace.

5. The system of claim 1, wherein each seller is a company and the company has one or more employees that are users of the marketplace.

6. The system of claim 1, wherein the social feed system further comprises a social shopping cart that allows the buyer and the user to communicate with each other during a checkout process.

7. The system of claim 1, wherein the social feed system further comprises a filter that filters the messages of the social feed system.

8. The system of claim 1, wherein the social feed system further comprises a private messaging system that allows one or more users of the social feed system to communicate with each other privately using a private network relationship.

9. The system of claim 1, wherein the social feed system further comprises business to business public messaging.

10. The system of claim 1, wherein the order management unit further comprises a dynamic order template.

11. The system of claim 1, wherein the social feed system further comprises a recommendation engine that matches a seller to a buyer.

12. The system of claim 1, wherein the marketplace further comprises a shipping cost module that determines a shipping cost for a purchased item.

13. The system of claim 1, wherein a first company and a second company connects to go into a social b2b relationship

14. The system of claim 13, wherein, as soon as a connection request is confirmed, the social feed structure is available between the two connected companies and coworkers of the two connected companies.

15. A social business to business marketplace method, comprising:
providing a marketplace for at least one seller and at least one buyer, the marketplace having a store front for each seller, a shopping cart for each buyer for each storefront of each seller, an order management unit that manages orders submitted using the shopping card and a payment management unit that manages the payment for orders to facilitate a transaction between a buyer and a seller who are users of the marketplace;
generating, using a social feed system that is integrated into the marketplace, an opportunity social feed to the seller when an item is placed into the shopping cart by a buyer;
generating, using a social feed system that is integrated into the marketplace, an order management social feed to the seller when the buyer submits a completed order;
generating, using a social feed system that is integrated into the marketplace, a purchase social feed to the seller; and
communicating, using the opportunity social feed, the order management social feed and the purchase social feed, between the buyer and seller during the transaction.

16. The method of claim 15 further comprising processing a payment transaction using a third party API.

17. The method of claim 15 further comprising inviting, using a recommendation engine of the system, a second company to the social business to business marketplace system.

18. The method of claim 15, wherein each buyer is a company and the company has one or more employees that are users of the marketplace.

19. The method of claim 15, wherein each seller is a company and the company has one or more employees that are users of the marketplace.

20. The method of claim 15 further comprising communicating, using a social shopping cart, between a buyer and a seller during a checkout process.

21. The method of claim 15 further comprising filtering the messages of the social feed system.

22. The method of claim 15 further comprising providing a private messaging system that allows one or more users of the social feed system to communicate with each other privately using a private network relationship.

23. The method of claim 15, wherein the social feed system further comprises business to business public messaging.

24. The method of claim 15 further comprising determining, using a shipping cost module of the system, a shipping cost for a purchased item.

25. The method of claim 15, wherein a first company and a second company connects to go into a social b2b relationship.

26. The method of claim 25, wherein, as soon as a connection request is confirmed, the social feed structure is available between the two connected companies and coworkers of the two connected companies.
